(19) United States
(12) Patent Application Publication
(10) Pub. No.: US 2023/0247495 A1
(43) Pub. Date: Aug. 3, 2023

(54) IAB NODE HANDOVER IN INTER-CU MIGRATION

(71) Applicant: Telefonaktiebolaget LM Ericsson (PUBL), Stockholm (SE)

(72) Inventors: Oumer Teyeb, MONTRÉAL (CA); Filip Barac, HUDDINGE (SE); Marco Belleschi, SOLNA (SE)

(21) Appl. No.: 18/002,384

(22) PCT Filed: Jun. 25, 2021
(86) PCT No.: PCT/EP2021/067519

§ 371 Date: Dec. 19, 2022

Related U.S. Application Data
(60) Provisional application No. 63/044,421, filed on Jun. 26, 2020.

(51) Int. Cl. H04W 36/00; H04W 36/12

(52) U.S. Cl. CPC H04W 36/0064; H04W 36/12; H04W 36/0072

(57) ABSTRACT

A method is performed by a target Central Unit (CU) during a handover of a migrating node from source CU and source Distributed Unit (DU) to the target CU and a target DU. The method includes transmitting, to the target DU, a first handover command for at least one child node of the migrating node being handed over from the source CU and source DU to the target CU and target DU.

### TECHNICAL FIELD

The present disclosure relates, in general, to wireless communications and, more particularly, systems and methods for Integrated Access and Wireless Backhaul (IAB) handover in an inter-Central Unit (inter-CU) migration.

### BACKGROUND

Third Generation Partnership Project (3GPP) wireless network specifications include IAB for 5th generation (5G) New Radio (NR) networks. Usage of short range mmWave spectrum in NR creates a need for densified deployment with multi-hop backhauling. However, optical fiber to every base station is too costly and sometimes not possible (e.g., historical sites). The main IAB principle is the use of wireless links for the backhaul (instead of fiber) to enable flexible and dense deployment of cells without the need for densifying the transport network. Use case scenarios for IAB can include coverage extension, deployment of massive number of small cells, and fixed wireless access (FWA) such as, for example, to residential/office buildings. The larger bandwidth available for NR in mmWave spectrum provides opportunity for self-backhauling without limiting the spectrum available for the access links. In addition, the inherent multi-beam and multiple input multiple output (MIMO) support in NR reduces cross-link interference between backhaul and access links facilitating higher densification.

The IAB architecture, which is discussed in 3GPP TR 38.874, may leverage the central unit (CU)/distributed unit (DU) split architecture of NR, where the IAB node hosts a DU part that is controlled by a CU. The IAB nodes also have a mobile termination (MT) part used to communicate with their parent nodes.

The IAB specifications may reuse other existing functions and interfaces defined in NR. In particular, MT, gNodeB-Distributed Unit (gNB-DU), gNodeB-Central Unit (gNB-CU), user plane function (UPF), access and mobility management function (AMF), and session management function (SMF), as well as the corresponding interfaces NR Uu (between MT and gNB), F1, NG, X2 and N4 that are used as baseline for the IAB architecture. Modifications or enhancements to these functions and interfaces for the support of IAB will be explained in the context of the architecture discussion. Additional functionality such as multi-hop forwarding is included in the architecture discussion as it is beneficial for the understanding of IAB operation.

The MT function is a component of the IAB node. As used herein, MT refers to a function residing on an IAB-node that terminates the radio interface layers of the backhaul Uu interface toward the IAB-donor or other IAB-nodes.

FIG. 1 illustrates a high-level architectural view of an example IAB network. Specifically, FIG. 1 is a reference diagram for IAB in standalone mode, where the IAB contains one IAB-donor and multiple IAB-nodes. The IAB-donor is treated as a single logical node that comprises a set of functions such as gNB-DU, gNodeB-Central Unit-Control Plane (gNB-CU-CP), gNodeB-Central Unit-User Plane (gNB-CU-UP), and potentially other functions. In a deployment, the IAB-donor can be split according to these functions, which can all be either collocated or non-collocated as allowed by 3GPP Next Generation-Radio Access Network (NG-RAN) architecture. IAB-related aspects may arise when such split is exercised. Also, some of the functions presently associated with the IAB-donor may be moved outside of the donor if it becomes evident that they do not perform IAB-specific tasks.

FIG. 2 illustrates the baseline user plane protocol stack for IAB. FIG. 3 illustrates the baseline control plane protocol stack for IAB. As illustrated in FIGS. 2 and 3, the chosen protocol stacks reuse the current CU-DU split specification, where the full user plane F1-U (General Packet Radio Service Tunneling Protocol-User Plane (GTP-U)/User Datagram Protocol (UDP)/Internet Protocol (IP)) is terminated at the IAB node (like a normal DU) and the full control plane F1-C (F1-Application Protocol (F1-AP)/Stream Control Transmission Protocol (SCTP)/IP) is also terminated at the IAB node (like a normal DU). In the above cases, Network Domain Security (NDS) has been employed to protect both UP and CP traffic (Internet Protocol Security (IPsec) in the case of UP and Datagram Transport Layer Security (DTLS) in the case of CP). IPsec could also be used for the CP protection instead of DTLS, and in this case no DTLS layer would be used.

The IAB nodes and IAB donor include the Backhaul Adaptation Protocol (BAP), which is used for routing of packets to the appropriate downstream/upstream node and also mapping the user equipment (UE) bearer data to the proper backhaul radio link control (RLC) channel (and also between ingress and egress backhaul RLC channels in intermediate IAB nodes) to satisfy the end to end Quality of Service (QoS) requirements of bearers.

On the IAB-node, the BAP sublayer contains one BAP entity at the MT function and a separate collocated BAP entity at the DU function. On the IAB-donor-DU, the BAP sublayer contains only one BAP entity. Each BAP entity has a transmitting part and a receiving part. The transmitting part of the BAP entity has a corresponding receiving part of a BAP entity at the IAB-node or IAB-donor-DU across the backhaul link.

FIG. 4 illustrates an example functional view of the BAP sublayer. Though FIG. 4 is based on the radio interface protocol architecture defined in 3GPP TS 38.300, the example architecture should not restrict implementation. In FIG. 4, the receiving part on the BAP entity delivers BAP protocol data units (PDUs) to the transmitting part on the collocated BAP entity. Alternatively, the receiving part may deliver BAP service data units (SDUs) to the collocated transmitting part. When passing BAP SDUs, the receiving part removes the BAP header and the transmitting part adds the BAP header with the same BAP routing Identifier (ID) as carried on the BAP PDU header prior to removal. Passing BAP SDUs in this manner is therefore functionally equivalent to passing BAP PDUs, in implementation.

The BAP sublayer provides data transfer services to upper layers. The BAP sublayer expects the following services from lower layers per RLC entity: acknowledged data transfer service and unacknowledged data transfer service. A detailed description is provided in 3GPP TS 38.322.

The BAP sublayer supports the following functions: data transfer; determination of BAP destination and path for packets from upper layers; determination of egress backhaul RLC channels for packets routed to next hop; routing of packets to next hop; differentiating traffic to be delivered to upper layers from traffic to be delivered to egress link; and flow control feedback and polling signaling.

FIG. 5 illustrates an example of some possible IAB-node migration cases listed in the order of complexity.

For example, in Intra-CU Case (A), the IAB-node (e) along with its serving UEs are moved to a new parent node (IAB-node (b)) under the same donor-DU (1). The successful intra-donor DU migration requires establishing UE context setup for the IAB-node (e) MT in the DU of the new parent node (IAB-node (b)), updating routing tables of IAB nodes along the path to IAB-node (e), and allocating resources on the new path. The IP address for IAB-node (e) will not change, while the F1-U tunnel/connection between donor-CU (1) and IAB-node (e) DU will be redirected through IAB-node (b).

As another example, in Intra-CU Case (B), the procedural requirements/complexity of this case is the same as that of Case (A). Also, because the new IAB-donor DU (i.e. DU2) is connected to the same L2 network, the IAB-node (e) can use the same IP address under the new donor DU. However, the new donor DU (i.e. DU2) will need to inform the network using IAB-node (e) L2 address in order to get/keep the same IP address for IAB-node (e) by employing some mechanism such as Address Resolution Protocol (ARP).

Intra-CU Case (C) is more complex than Case (A), as it also needs allocation of new IP address for IAB-node (e). Where IPsec is used for securing the F1-U tunnel/connection between the Donor-CU (1) and IAB-node (e) DU, it might be possible to use the existing IP address along the path segment between the Donor-CU (1) and Security Gateway (SeGW), and a new IP address for the IPsec tunnel between SeGW and IAB-node (e) DU.

As another example, Inter-CU Case (D), is the most complicated case in terms of procedural requirements and may need new specification procedures that are beyond the scope of 3GPP Rel-16.

It may be noted that 3GPP Rel-16 has standardized procedure only for intra-CU migration. Specifically, during the intra-CU topology adaptation, both the source and the target parent node are served by the same IAB-donor-CU. The target parent node may use a different IAB-donor-DU than the source parent node. The source path may further have common nodes with the target path.

FIG. 6 illustrates an example IAB intra-CU topology adaptation procedure, where the target parent node uses a different IAB-donor-DU than the source parent node. Specifically, the illustrated intra-CU topology adaptation procedure includes:
1. The migrating IAB-MT sends a Measurement Report message to the source parent node gNB-DU. The report is based on a Measurement Configuration the migrating IAB-MT received from the IAB-donor-CU before.
2. The source parent node gNB-DU sends an UL RRC MESSAGE TRANSFER message to the IAB-donor-CU to convey the received Measurement Report.
3. The IAB-donor-CU sends a UE CONTEXT SETUP REQUEST message to the target parent node gNB-DU to create the UE context for the migrating IAB-MT and setup one or more bearers. These bearers are used by the migrating IAB-MT for its own data and signaling traffic.
4. The target parent node gNB-DU responds to the IAB-donor-CU with a UE CONTEXT SETUP RESPONSE message.
5. The IAB-donor-CU sends a UE CONTEXT MODIFICATION REQUEST message to the source parent node gNB-DU, which includes a generated RRCReconfiguration message. The Transmission Action Indicator in the UE CONTEXT MODIFICATION REQUEST message indicates to stop the data transmission to the migrating IAB-node.
6. The source parent node gNB-DU forwards the received RRCReconfiguration message to the migrating IAB-MT.
7. The source parent node gNB-DU responds to the IAB-donor-CU with the UE CONTEXT MODIFICATION RESPONSE message.
8. A Random Access (RA) procedure is performed at the target parent node gNB-DU.
9. The migrating IAB-MT responds to the target parent node gNB-DU with an RRCReconfigurationComplete message.
10. The target parent node gNB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node gNB-DU. These downlink (DL) and uplink (UL) packets belong to the MT's own signaling and data traffic.
11. The IAB-donor-CU configures BH RLC channels and BAP-layer route entries on the target path between migrating IAB-node and target IAB-donor-DU. This step also includes allocation of Transport Network Layer (TNL) address(es) that is (are) routable via the target IAB-donor-DU. These configurations may be performed at an earlier stage, e.g. right after step 3. The new TNL address(es) is (are) included in the RRCReconfiguration message at step 5.
12. All F1-U tunnels and F1-C are switched to use the migrating IAB-node's new TNL address(es).
13. The IAB-donor-CU sends a UE CONTEXT RELEASE COMMAND message to the source parent node gNB-DU.
14. The source parent node gNB-DU releases the migrating IAB-MT's context and responds the IAB-donor-CU with a UE CONTEXT RELEASE COMPLETE message.
15. The IAB-donor-CU releases BH RLC channels and BAP routing entries on the source path. The migrating IAB-node may further release the TNL address(es) it used on the source path.

If the source route and target route have common nodes, the BH RLC channels and BAP routing entries of those nodes may not need to be released in Step 15.

Steps 11, 12 and 15 are also performed for the migrating IAB-node's descendant nodes, as follows:
The descendant nodes switch to new TNL addresses that are anchored in the target IAB-donor-DU. The IAB-donor-CU may send these addresses to the descendant nodes and release the old addresses via corresponding radio resource control (RRC) signaling.
If needed, the IAB-donor-CU configures BH RLC channels, BAP-layer route entries on the target path for the descendant nodes and the BH RLC Channel mappings on the descendant nodes in the same manner as described for the migrating IAB-node in step 11.
The descendant nodes switch their F1-U and F1-C tunnels to new TNL addresses that are anchored at the new IAB-donor-DU, in the same manner as described for the migrating IAB-node in step 12.
Based on implementation, these steps can be performed after or in parallel with the handover of the migrating IAB-node. In Rel-16, in-flight packets in UL direction that were dropped during the migration procedure may not be recoverable.

In the upstream direction, in-flight packets between the source parent node and the IAB-donor-CU can be delivered even after the target path is established. On-going downlink data in the source path may be discarded. It is up to implementation. The IAB-donor-CU can determine the unsuccessfully transmitted downlink data over the backhaul link by implementation.

Particular procedures for a CU/DU split architecture are described in 3GPP TS 38.401. The procedures are between the CU and DU (as well as the CU-CP and CU-UP if the CU is split into UP and CP functions. Specifically, as disclosed in FIG. 8.9.2-1 of 3GPP TS 38.401, the procedure used to setup the bearer context over F1-U in the gNB-CU-UP may include:
0. Bearer context setup (e.g., following an SGNB ADDITION REQUEST message from the MeNB) is triggered in gNB-CU-CP.
1. The gNB-CU-CP sends a BEARER CONTEXT SETUP REQUEST message containing uplink (UL) TNL address information for S1-U or NG-U, and if required, downlink (DL) TNL address information for X2-U or Xn-U to setup the bearer context in the gNB-CU-UP. For NG-RAN, the gNB-CU-CP decides flow-to-DRB mapping and sends the generated SDAP and PDCP configuration to the gNB-CU-UP.
2. The gNB-CU-UP responds with a BEARER CONTEXT SETUP RESPONSE message containing the UL TNL address information for F1-U, and DL TNL address information for S1-U or NG-U, and if required, UL TNL address information for X2-U or Xn-U.
   The indirect data transmission for split bearer through the gNB-CU-UP is not precluded.
3. F1 UE context setup procedure is performed to setup one or more bearers in the gNB-DU.
4. The gNB-CU-CP sends a BEARER CONTEXT MODIFICATION REQUEST message containing the DL TNL address information for F1-U and PDCP status.
5. The gNB-CU-UP responds with a BEARER CONTEXT MODIFICATION RESPONSE message.

Additionally, as disclosed in FIG. 8.9.3.1-1 of 3GPP TS 38.401, the procedure used to release the bearer context over F1-U in the gNB-CU-UP, as initiated by the gNB-CU-CP, includes:
0. Bearer context release (e.g., following an SGNB RELEASE REQUEST message from the MeNB) is triggered in gNB-CU-CP.
1. The gNB-CU-CP sends a BEARER CONTEXT MODIFICATION REQUEST message to the gNB-CU-UP.
2. The gNB-CU-UP responds with a BEARER CONTEXT MODIFICATION RESPONSE carrying the PDCP UL/DL status.
3. F1 UE context modification procedure is performed to stop the data transmission for the UE. It is up to gNB-DU implementation when to stop the UE scheduling.
   Steps 1-3 are performed only if the PDCP status of the bearer(s) needs to be preserved e.g., for bearer type change.
4. The gNB-CU-CP may receive the UE CONTEXT RELEASE message from the MeNB in EN-DC operation as described in Section 8.4.2.1.
5 and 7. Bearer context release procedure is performed.
6. F1 UE context release procedure is performed to release the UE context in the gNB-DU.

As disclosed in FIG. 8.9.3.2-1 of 3GPP TS 38.401, the procedure used to release the bearer context in the gNB-CU-UP initiated by the gNB-CU-UP includes:
0. Bearer context release is triggered in gNB-CU-UP e.g., due to local failure.
1. The gNB-CU-UP sends a BEARER CONTEXT RELEASE REQUEST message to request the release of the bearer context in the gNB-CU-UP. This message may contain the PDCP status.
2.-5. If the PDCP status needs to be preserved, the E1 Bearer Context Modification and the F1 UE Context Modification procedures are performed. The E1 Bearer Context Modification procedure is used to convey data forwarding information to the gNB-CU-UP. The gNB-CU-CP may receive the UE Context Release from the MeNB.
6. The gNB-CU-CP sends a BEARER CONTEXT RELEASE COMMAND message to release the bearer context in the gNB-CU-UP.
7. The gNB-CU-UP responds with a BEARER CONTEXT RELEASE COMPLETE to confirm the release of the bearer context including also data forwarding information.
8. F1 UE context release procedure may be performed to release the UE context in the gNB-DU.

As disclosed in 3GPP TS 37.340, The procedure used for inter-gNB handover involving gNB-CU-UP change is illustrated and disclosed in FIG. 8.9.4-1 of 3GPP TS 37.340. The procedure includes:
1. The source gNB-CU-CP sends HANDOVER REQUEST message to the target gNB-CU-CP.
2-4. Bearer context setup procedure is performed as described in Section 8.9.2.
5. The target gNB-CU-CP responds the source gNB-CU-CP with an HANDOVER REQUEST ACKNOWLEDGE message.
6. The F1 UE Context Modification procedure is performed to stop UL data transmission at the gNB-DU and to send the handover command to the UE.
7-8. Bearer context modification procedure (gNB-CU-CP initiated) is performed to enable the gNB-CU-CP to retrieve the PDCP UL/DL status and to exchange data forwarding information for the bearer.
9. The source gNB-CU-CP sends an SN STATUS TRANSFER message to the target gNB-CU-CP.
10-11. Bearer context modification procedure is performed as described in Section 8.9.2.
12. Data Forwarding may be performed from the source gNB-CU-UP to the target gNB-CU-UP.
13-15. Path Switch procedure is performed to update the DL TNL address information for the NG-U towards the core network.
16. The target gNB-CU-CP sends an UE CONTEXT RELEASE message to the source gNB-CU-CP.
17. and 19. Bearer context release procedure is performed.
18. F1 UE context release procedure is performed to release the UE context in the source gNB-DU.

The procedure used for the change of gNB-CU-UP within a gNB is discussed and illustrated in FIG. 8.9.5-1 of 3GPP TS 37.340. The procedure includes:
1. Change of gNB-CU-UP is triggered in gNB-CU-CP based on e.g., measurement report from the UE.
2-3. Bearer Context Setup procedure is performed as described in Section 8.9.2.
4. F1 UE Context Modification procedure is performed to change the UL TNL address information for F1-U for one or more bearers in the gNB-DU.
5-6. Bearer Context Modification procedure (gNB-CU-CP initiated) is performed to enable the gNB-CU-CP to retrieve the PDCP UL/DL status and to exchange data forwarding information for the bearer.
7-8. Bearer Context Modification procedure is performed as described in Section 8.9.2.
9. Data Forwarding may be performed from the source gNB-CU-UP to the target gNB-CU-UP.
10-12. Path Switch procedure is performed to update the DL TNL address information for the NG-U towards the core network.
13-14. Bearer Context Release procedure (gNB-CU-CP initiated) is performed as described in Section 8.9.3.

Xn procedures for mobility are described in 3GPP TS 38.423. The following summarizes the core messages/procedures and information elements that are used for mobility of UEs (these messages were referred in the signaling diagrams above).

The HANDOVER REQUEST message is sent by the source Next Generation-Radio Access Network (NG-RAN) node to the target NG-RAN node to request the preparation of resources for a handover. Thus, the direction is from the source NG-RAN node to the target NG-RAN node. Table 1 discloses elements of the HANDOVER REQUEST message.

TABLE 1

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN | M | | NG-RAN node | Allocated at the | YES | reject |
| node UE XnAP ID | | | UE XnAP ID | source NG-RAN | | |
| reference | | | 9.2.3.16 | node | | |
| Cause | M | | 9.2.3.2 | | YES | reject |
| Target Cell Global | M | | 9.2.3.25 | Includes either an | YES | reject |
| ID | | | | E-UTRA CGI or an | | |
| | | | | NR CGI | | |
| GUAMI | M | | 9.2.3.24 | | YES | reject |
| UE Context | | 1 | | | YES | reject |
| Information | | | | | | |
| >NG-C UE | M | | AMF UE NGAP | Allocated at the | — | |
| associated | | | ID | AMF on the source | | |
| Signalling | | | 9.2.3.26 | NG-C connection. | | |
| reference | | | | | | |
| >Signalling TNL | M | | CP Transport | This IE indicates | — | |
| association | | | Layer | the AMF’s IP | | |
| address at source | | | Information | address of the | | |
| NG-C side | | | 9.2.3.31 | SCTP association | | |
| | | | | used at the source | | |
| | | | | NG-C interface | | |
| | | | | instance. | | |
| | | | | Note: If no UE | | |
| | | | | TNLA binding | | |
| | | | | exists at the source | | |
| | | | | NG-RAN node, the | | |
| | | | | source NG-RAN | | |
| | | | | node indicates the | | |
| | | | | TNL association | | |
| | | | | address it would | | |
| | | | | have selected if it | | |
| | | | | would have had to | | |
| | | | | create a UE TNLA | | |
| | | | | binding. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection Priority | | | | | | |
| >UE Aggregate | M | | 9.2.3.17 | | — | |
| Maximum Bit | | | | | | |
| Rate | | | | | | |
| >PDU Session | | 1 | 9.2.1.1 | Similar to NG-C | — | |
| Resources To Be | | | | signalling, | | |
| Setup List | | | | containing UL | | |
| | | | | tunnel information | | |
| | | | | per PDU Session | | |
| | | | | Resource; | | |
| | | | | and in addition, the | | |
| | | | | source side QoS | | |
| | | | | flow □ DRB | | |
| | | | | mapping | | |
| >RRC Context | M | | OCTET STRING | Either includes the | — | |
| | | | | HandoverPreparation- | | |
| | | | | Information | | |
| | | | | message as defined | | |
| | | | | in subclause 10.2.2. | | |
| | | | | of TS 36.331 [14], | | |
| | | | | if the target NG- | | |
| | | | | RAN node is an | | |
| | | | | ng-eNB, or the | | |
| | | | | HandoverPreparation- | | |
| | | | | Information | | |
| | | | | message as defined | | |
| | | | | in subclause 11.2.2 | | |
| | | | | of TS 38.331 [10], | | |
| | | | | if the target NG- | | |
| | | | | RAN node is a | | |
| | | | | gNB. | | |
| >Location | O | | 9.2.3.47 | Includes the | — | |
| Reporting | | | | necessary | | |
| Information | | | | parameters for | | |
| | | | | location reporting. | | |
| >Mobility | O | | 9.2.3.53 | | — | |
| Restriction List | | | | | | |
| Trace Activation | O | | 9.2.3.55 | | YES | ignore |
| Masked IMEISV | O | | 9.2.3.32 | | YES | ignore |
| UE History | M | | 9.2.3.64 | | YES | ignore |
| Information | | | | | | |
| UE Context | O | | | | YES | ignore |
| Reference at the | | | | | | |
| S-NG-RAN node | | | | | | |
| >Global NG-RAN | M | | 9.2.2.3 | | — | |
| Node ID | | | | | | |
| >S-NG-RAN node | M | | NG-RAN node | | — | |
| UE XnAP ID | | | UE XnAP ID | | | |
| | | | 9.2.3.16 | | | |

In Table 1, CGI refers Cell Global Identifier, and E-UTRA refers to Evolved Universal Terrestrial Radio Access. GUAMI refers to Globally Unique AMF ID.

The HANDOVER REQUEST ACKNOWLEDGE message is sent by the target NG-RAN node to inform the source NG-RAN node about the prepared resources at the target. Thus, the direction is from the target NG-RAN node to the source NG-RAN node. Table 2 discloses elements of the HANDOVER REQUEST ACKNOWLEDGE message.

TABLE 2

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN | M | | NG-RAN node | Allocated at the | YES | ignore |
| node UE XnAP ID | | | UE XnAP ID | source NG-RAN | | |
| | | | 9.2.3.16 | node | | |
| Target NG-RAN | M | | NG-RAN node | Allocated at the | YES | ignore |
| node UE XnAP ID | | | UE XnAP ID | target NG-RAN | | |
| | | | 9.2.3.16 | node | | |
| PDU Session | M | | 9.2.1.2 | | YES | ignore |
| Resources | | | | | | |
| Admitted List | | | | | | |
| PDU Session | O | | 9.2.1.3 | | YES | ignore |
| Resources Not | | | | | | |
| Admitted List | | | | | | |
| Target NG-RAN | M | | OCTET STRING | Either includes the | YES | ignore |
| node To Source | | | | HandoverCommand | | |
| NG-RAN node | | | | message as defined | | |
| Transparent | | | | in subclause 10.2.2 | | |
| Container | | | | of TS 36.331 [14], | | |
| | | | | if the target | | |
| | | | | NG-RAN node is | | |
| | | | | an ng-eNB, or the | | |
| | | | | HandoverCommand | | |
| | | | | message as | | |
| | | | | defined in | | |
| | | | | subclause 11.2.2 of | | |
| | | | | TS 38.331 [10], if | | |
| | | | | the target NG-RAN | | |
| | | | | node is a gNB. | | |
| UE Context Kept | O | | 9.2.3.68 | | YES | ignore |
| Indicator | | | | | | |
| Criticality | O | | 9.2.3.3 | | YES | ignore |
| Diagnostics | | | | | | |
| DRBs transferred | O | | DRB List | In case of DC, | YES | ignore |
| to MN | | | 9.2.1.29 | indicates that SN | | |
| | | | | Status is needed for | | |
| | | | | the listed DRBs | | |
| | | | | from the S-NG- | | |
| | | | | RAN node. | | |

The HandoverCommand (from 3GPP TS 38.331) is used to transfer the handover command as generated by the target gNB. Thus, the direction is from the target gNB to source gNB/source RAN. The HandoverCommand follows:

HandoverCommand message

-- ASN1START
-- TAG-HANDOVER-COMMAND-START

| | |
|---|---|
| HandoverCommand ::= | SEQUENCE { |

| | |
|---|---|
| criticalExtensions | CHOICE { |

| | |
|---|---|
| c1 | CHOICE{ |

| | |
|---|---|
| handoverCommand | HandoverCommand-IEs, |

```
      spare3 NULL, spare2 NULL, spare1 NULL
    },
```

| | |
|---|---|
| criticalExtensionsFuture | SEQUENCE { } |

}
}

| | |
|---|---|
| HandoverCommand-IEs ::= | SEQUENCE { |

| | |
|---|---|
| handoverCommandMessage | OCTET STRING (CONTAINING |

RRCReconfiguration),

| | |
|---|---|
| nonCriticalExtension | SEQUENCE { } |

OPTIONAL
}
-- TAG-HANDOVER-COMMAND-STOP
-- ASN1STOP

HandoverCommand field descriptions

handoverCommandMessage
Contains the RRCReconfiguration message used to perform handover
within NR or handover to NR, as generated (entirely) by the target gNB.

The HANDOVER PREPARATION FAILURE message is sent by the target NG-RAN node to inform the source NG-RAN node that the Handover Preparation has failed. Thus, the direction is from the target NG-RAN node to the source NG-RAN node. TABLE 4 discloses elements of the HANDOVER PREPARATION FAILURE message.

TABLE 4

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN | M | | NG-RAN node | Allocated at the | YES | ignore |
| node UE XnAP ID | | | UE XnAP ID | source NG-RAN | | |
| | | | 9.2.3.16 | node | | |
| Cause | M | | 9.2.3.2 | | YES | ignore |
| Criticality | O | | 9.2.3.3 | | YES | ignore |
| Diagnostics | | | | | | |

The HANDOVER CANCEL message is sent by the source NG-RAN node to the target NG-RAN node to cancel an ongoing handover. Thus, the direction is from the source NG-RAN node to the target NG-RAN node. Table 5 discloses elements of the HANDOVER CANCEL message.

TABLE 5

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| Source NG-RAN | M | | NG-RAN node | Allocated at the | YES | reject |
| node UE XnAP ID | | | UE XnAP ID | source NG-RAN | | |
| | | | 9.2.3.16 | node. | | |
| Target NG-RAN | O | | NG-RAN node | Allocated at the | YES | ignore |
| node UE XnAP ID | | | UE XnAP ID | target NG-RAN | | |
| | | | 9.2.3.16 | node. | | |
| Cause | M | | 9.2.3.2 | | YES | ignore |

The PDU Session Resources To Be Setup List IE contains PDU session resource related information used at UE context transfer between NG-RAN nodes, as disclosed in Table 6.

TABLE 6

| | | | IE type and | Semantics | | Assigned |
|---|---|---|---|---|---|---|
| IE/Group Name | Presence | Range | reference | description | Criticality | Criticality |
| PDU Session | | 1 | | | — | |
| Resources To | | | | | | |
| Be Setup List | | | | | | |
| >PDU Session | | 1 .. | | | — | |
| Resources To | | <maxno | | | | |
| Be Setup Item | | of PDU | | | | |
| | | sessions> | | | | |
| >>PDU | M | | 9.2.3.18 | | — | |
| Session ID | | | | | | |
| >>S-NSSAI | M | | 9.2.3.21 | | — | |
| >>PDU | O | | PDU Session | This IE shall be | — | |
| Session | | | Aggregate | present when at | | |
| Resource | | | Maximum Bit | least one Non-GBR | | |
| Aggregate | | | Rate | QoS Flow has been | | |
| Maximum | | | 9.2.3.69 | setup. | | |
| Bitrate | | | | | | |
| >>UL NG-U | M | | UP Transport | UPF endpoint of the | — | |
| UP TNL | | | Layer | NG-U transport | | |
| Information at | | | Information | bearer. For delivery | | |
| UPF | | | 9.2.3.30 | of UL PDUs | | |
| >>Additional | O | | Additional UP | Additional UPF | YES | ignore |
| UL NG-U UP | | | Transport Layer | endpoint of the NG- | | |
| TNL | | | Information | U transport bearer. | | |
| Information at | | | 9.2.1.32 | For delivery of UL | | |
| UPF List | | | | PDUs | | |
| >>Source DL | O | | UP Transport | Indicates the | — | |
| NG-U TNL | | | Layer | possibility to keep | | |
| Information | | | Information | the NG-U GTP-U | | |
| | | | 9.2.3.30 | tunnel termination | | |
| | | | | point at the target | | |
| | | | | NG-RAN node. | | |
| >>Security | O | | 9.2.3.52 | | — | |
| Indication | | | | | | |
| >>PDU | M | | 9.2.3.19 | | — | |
| Session Type | | | | | | |
| >>Network | O | | 9.2.3.85 | This IE is ignored if | — | |
| Instance | | | | the Common | | |
| | | | | Network Instance IE | | |
| | | | | is present. | | |
| >>QoS Flows | | 1 | | | — | |
| To Be Setup | | | | | | |
| List | | | | | | |
| >>>QoS | | 1 .. | | | — | |
| Flows To Be | | <maxno- | | | | |
| Setup Item | | ofQoS- | | | | |
| | | Flows> | | | | |
| >>>>QoS | M | | 9.2.3.10 | | — | |
| Flow | | | | | | |
| Identifier | | | | | | |
| >>>>QoS | M | | 9.2.3.5 | | — | |
| Flow Level | | | | | | |
| QoS | | | | | | |
| Parameters | | | | | | |
| >>>>E- | O | | INTEGER | | — | |
| RAB ID | | | (0..15, ...) | | | |
| >>Data | O | | 9.2.1.17 | | — | |
| Forwarding | | | | | | |
| and | | | | | | |
| Offloading | | | | | | |
| Info from | | | | | | |
| source NG- | | | | | | |
| RAN node | | | | | | |
| >>Common | O | | 9.2.3.92 | | YES | ignore |
| Network | | | | | | |
| Instance | | | | | | |

| Range bound | Explanation |
|---|---|
| maxnoofPDUSessions | Maximum no. of PDU sessions. Value is 256 |
| maxnoofQoSFlows | Maximum no. of QoS flows allowed within one PDU |
| | session. Value is 64. |

The PDU Session Resources Admitted List IE contains PDU session resource related information to report success of the establishment of PDU session resources, as disclosed in Table 7.

TABLE 7

| | | | IE type and | Semantics | | Assigned |
|---|---|---|---|---|---|---|
| IE/Group Name | Presence | Range | reference | description | Criticality | Criticality |
| PDU Session | | 1 | | | — | |
| Resources | | | | | | |
| Admitted List | | | | | | |
| >PDU Session | | 1.. <max- | | | — | |
| Resources | | noofPDU- | | | | |
| Admitted Item | | Sessions> | | | | |
| >>PDU | M | | 9.2.3.18 | | — | |
| Session ID | | | | | | |
| >>PDU | M | | | | — | |
| Session | | | | | | |
| Resource | | | | | | |
| Admitted Info | | | | | | |
| >>>DL NG-U | O | | ENUMERATED | Indicates the | — | |
| TNL | | | (True, ...) | NG-U tunnels | | |
| Information | | | | that have been | | |
| Unchanged | | | | kept unchanged | | |
| | | | | at the target NG- | | |
| | | | | RAN node | | |
| >>>QoS | | 1 | | | — | |
| Flows | | | | | | |
| Admitted | | | | | | |
| List | | | | | | |
| >>>>QoS | | 1.. <max- | | | — | |
| Flows | | noofQoS- | | | | |
| Admitted | | Flows> | | | | |
| Item | | | | | | |
| >>>>>QoS | M | | 9.2.3.10 | | — | |
| Flow | | | | | | |
| Identifier | | | | | | |
| >>>QoS | O | | QoS Flow | | — | |
| Flows not | | | List with | | | |
| Admitted | | | Cause | | | |
| List | | | 9.2.1.4 | | | |
| >>>Data | O | | 9.2.1.16 | | — | |
| Forwarding | | | | | | |
| Info from | | | | | | |
| target NG- | | | | | | |
| RAN node | | | | | | |
| >>>Secondary | O | | 9.2.1.31 | This IE would | YES | ignore |
| Data | | | | be present only | | |
| Forwarding | | | | when the target | | |
| Info from | | | | M-NG-RAN | | |
| target NG- | | | | node decide to | | |
| RAN node | | | | split a PDU | | |
| List | | | | session between | | |
| | | | | MN and SN | | |

| Range bound | Explanation |
|---|---|
| maxnoofPDUSessions | Maximum no. of PDU sessions. Value is 256 |
| maxnoofQoSFlows | Maximum no. of QoS flows allowed within one PDU |
| | session. Value is 64. |

The PDU Session Resources Not Admitted List IE contains a list of PDU session resources which were not admitted to be added or modified, as disclosed in TABLE 8.

TABLE 8

| | | | IE type and | Semantics |
|---|---|---|---|---|
| IE/Group Name | Presence | Range | reference | description |
| PDU Session | | 1 | | |
| Resources Not | | | | |
| Admitted List | | | | |
| >PDU Session | | l . . . <maxno- | | |
| Resources Not | | ofPDUSessions> | | |
| Admitted Item | | | | |
| >>PDU Session | M | | 9.2.3.18 | |
| ID | | | | |
| >>Cause | O | | 9.2.3.2 | |

| Range bound | Explanation |
|---|---|
| maxnoofPDUSessions | Maximum no. of PDU sessions. Value is 256 |

The QoS Flow Identifier IE identifies a QoS Flow within a PDU Session. Definition and use of the QoS Flow Identifier is specified in 3GPP TS 23.501 and is shown in Table 9.

TABLE 9

| | | | IE type and | Semantics |
|---|---|---|---|---|
| lE/Group Name | Presence | Range | reference | description |
| QoS Flow | M | | INTEGER | |
| Identifier | | | (0 . . . 63, . . . ) | |

F1 signaling and procedures are described in 3GPP TS 38.473 and summarized below.

The INITIAL UL RRC MESSAGE TRANSFER message is sent by the gNB-DU to transfer the initial layer 3 message to the gNB-CU over the F1 interface. Thus, the direction is from the gNB-DU to the gNB-CU. Table 10 discloses elements of the INITIAL UL RRC MESSAGE TRANSFER message.

TABLE 10

| IE/Group | | | IE type and | Semantics | | Assigned |
|---|---|---|---|---|---|---|
| Name | Presence | Range | reference | description | Criticality | Criticality |
| Message Type | M | | 9.3.1.1 | | YES | ignore |
| gNB-DU UE | M | | 9.3.1.5 | | YES | reject |
| F1AP ID | | | | | | |
| NR CGI | M | | 9.3.1.12 | NG-RAN Cell | YES | reject |
| | | | | Global Identifier | | |
| | | | | (NR CGI) | | |
| C-RNTI | M | | 9.3.1.32 | C-RNTI | YES | reject |
| | | | | allocated at the | | |
| | | | | gNB-DU | | |
| RRC-Container | M | | 9.3.1.6 | Includes the UL- | YES | reject |
| | | | | CCCH-Message | | |
| | | | | IE as defined in | | |
| | | | | subclause 6.2 of | | |
| | | | | TS 38.331 [8]. | | |
| DU to CU | O | | OCTET | CellGroupConfig | YES | reject |
| RRC Container | | | STRING | IE as defined | | |
| | | | | in subclause | | |
| | | | | 6.3.2 in TS | | |
| | | | | 38.331 [8]. | | |
| | | | | Required at least | | |
| | | | | to carry SRB1 | | |
| | | | | configuration. | | |
| | | | | The | | |
| | | | | Reconfiguration | | |
| | | | | WithSync field | | |
| | | | | is not included | | |
| | | | | in the | | |
| | | | | CellGroupConfig | | |
| | | | | IE. | | |
| SUL Access | O | | ENUMERATED | | YES | ignore |
| Indication | | | (true, ...) | | | |
| Transaction ID | M | | 9.3.1.23 | | YES | Ignore |
| RAN UE ID | O | | OCTET | | YES | ignore |
| | | | STRING | | | |
| | | | (SIZE (8)) | | | |
| RRC- | O | | 9.3.1.6 | Includes the UL- | YES | ignore |
| Container- | | | | DCCH-Message | | |
| RRCSetup- | | | | IE including the | | |
| Complete | | | | RRCSetup- | | |
| | | | | Complete message, | | |
| | | | | as defined in | | |
| | | | | subclause 6.2 of | | |
| | | | | TS 38.331 [8]. | | |

In Table 10, C-RNTI refers to a Cell specific Radio Network Temporary Identifier.

The DL RRC MESSAGE TRANSFER message is sent by the gNB-CU to transfer the layer 3 message to the gNB-DU over the F1 interface. Thus, the direction is from the gNB-CU to the gNB-DU. Table 11 discloses elements of the DL RRC MESSAGE TRANSFER message.

TABLE 11

| IE/Group | | | IE type and | Semantics | | Assigned |
|---|---|---|---|---|---|---|
| Name | Presence | Range | reference | description | Criticality | Criticality |
| Message Type | M | | 9.3.1.1 | | YES | ignore |
| gNB-CU UE | M | | 9.3.1.4 | | YES | reject |
| F1AP ID | | | | | | |
| gNB-DU UE | M | | 9.3.1.5 | | YES | reject |
| F1AP ID | | | | | | |
| old gNB-DU | O | | 9.3.1.5 | | YES | reject |
| UE F1AP ID | | | | | | |
| SRB ID | M | | 9.3.1.7 | | YES | reject |
| Execute | O | | ENUMERATED | | YES | ignore |
| Duplication | | | (true, ...) | | | |
| RRC-Container | M | | 9.3.1.6 | Includes the DL- | YES | reject |
| | | | | DCCH-Message | | |
| | | | | IE as defined in | | |
| | | | | subclause 6.2 of | | |
| | | | | TS 38.331 [8] | | |
| | | | | encapsulated in a | | |
| | | | | PDCP PDU, or | | |
| | | | | the DL-CCCH- | | |
| | | | | Message IE as | | |
| | | | | defined in | | |
| | | | | subclause 6.2 of | | |
| | | | | TS 38.331 [8]. | | |
| RAT- | O | | 9.3.1.34 | | YES | reject |
| Frequency | | | | | | |
| Priority | | | | | | |
| Information | | | | | | |
| RRC Delivery | O | | ENUMERATED | Indicates | YES | ignore |
| Status Request | | | (true, ...) | whether RRC | | |
| | | | | DELIVERY | | |
| | | | | REPORT | | |
| | | | | procedure is | | |
| | | | | requested for the | | |
| | | | | RRC message. | | |
| UE Context not | O | | ENUMERATED | | YES | reject |
| retrievable | | | (true, ...) | | | |
| Redirected | O | | RRC | Includes the UL- | YES | reject |
| RRC message | | | Container | DCCH-Message | | |
| | | | 9.3.1.6 | IE as defined in | | |
| | | | | subclause 6.2 of | | |
| | | | | TS 38.331 [8], | | |
| | | | | encapsulated in a | | |
| | | | | PDCP PDU. | | |
| PLMN | O | | PLMN | | YES | ignore |
| Assistance Info | | | Identify | | | |
| for Network | | | 9.3.1.14 | | | |
| Sharing | | | | | | |
| New gNB-CU | O | | gNB-CU UE | | YES | reject |
| UE F1AP ID | | | F1AP ID | | | |
| | | | 9.3.1.4 | | | |
| Additional | O | | 9.3.1.90 | | YES | ignore |
| RRM Policy | | | | | | |
| Index | | | | | | |

As used herein, PLMN refers to Public Land Mobile Network, and PLMN ID refers to PLMN Identity. RRM refers to Radio Resource Management.

The UL RRC MESSAGE TRANSFER message is sent by the gNB-DU to transfer the layer 3 message to the gNB-CU over the F1 interface. Thus, the direction is from the gNB-DU to the gNB-CU. Table 12 discloses elements of the UL RRC MESSAGE TRANSFER message.

TABLE 12

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.3.1.1 | | YES | ignore |
| gNB-CU UE | M | | 9.3.1.4 | | YES | reject |
| F1AP ID | | | | | | |
| gNB-DU UE | M | | 9.3.1.5 | | YES | reject |
| F1AP ID | | | | | | |
| SRB ID | M | | 9.3.1.7 | | YES | reject |
| RRC-Container | M | | 9.3.1.6 | Includes the UL- | YES | reject |
| | | | | DCCH-Message | | |
| | | | | IE as defined in | | |
| | | | | subclause 6.2 of | | |
| | | | | TS 38.331 [8], | | |
| | | | | encapsulated in a | | |
| | | | | PDCP PDU. | | |
| Selected | O | | PLMN | | YES | reject |
| PLMN ID | | | Identity | | | |
| | | | 9.3.1.14 | | | |
| New gNB-DU | O | | gNB- | | YES | reject |
| UE F1AP ID | | | DU UE | | | |
| | | | F1AP ID | | | |
| | | | 9.3.1.5 | | | |

The RRC DELIVERY REPORT message is sent by the gNB-DU to inform the gNB-CU about the delivery status of DL RRC messages. Thus, the direction is from the gNB-DU to the gNB-CU. Table 13 discloses elements of the RRC DELIVERY REPORT message.

TABLE 13

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| gNB-CU UE | M | | 9.3.1.4 | | YES | reject |
| F1AP ID | | | | | | |
| gNB-DU UE | M | | 9.3.1.5 | | YES | reject |
| F1AP ID | | | | | | |
| RRC Delivery | M | | 9.3.1.71 | | YES | ignore |
| Status | | | | | | |
| SRB ID | M | | 9.3.1.7 | | YES | ignore |

There currently exist certain challenges. For example, as described above 3GPP has standardized only IAB intra-CU migration procedure. Considering that inter-CU migration is an important feature of IAB, enhancements to existing UE handover and IAB intra-CU migration procedure are required for reducing service interruption (due to IAB-node migration) and signaling load.

Techniques have been used for transferring to the target CU the information/context of the migrating IAB node as well as all the UEs and IAB nodes that are directly or indirectly served by the IAB nodes. The target CU uses the information to perform proper admission control. The target CU-CP responds to the HANDOVER REQUEST with a HANDOVER REQUEST ACK that indicates the list of admitted and not admitted PDU session resources (for each concerned UE/IAB node included in the handover request), which is essentially the list of the QoS flows associated with each UE/IAB-MT.

FIG. 7 illustrates an example IAB network scenario, where IAB 3 is being migrated from donor CU1 to CU2 (and parent node IAB1 to IAB2). Even though only the IAB-3 MT is actually changing its receiving/transmitting radio connection towards the new parent (IAB-2 DU), all the UEs and IAB nodes that are directly or indirectly served by the IAB-3 must also receive a handover command (i.e. RRC Reconfiguration message containing reconfigurationWithSync) for changing the security keys as their context is relocated, even if they are still connected to the same IAB node as before (3GPP security specifications mandate a security key change whenever the PDCP termination point changes).

Currently, there is no specified group handover procedure, and thus it is not clear on how and when the handover command to the individual IAB-MTs and UEs are sent. This especially becomes problematic when the migrating IAB node is not a leaf node (i.e. when it serves other IAB nodes under it).

### SUMMARY

Certain aspects of the present disclosure and their embodiments may provide solutions to these or other challenges. For example, particular embodiments handle the signaling of the handover commands to the IAB nodes MTs' and UEs' that are impacted by the Integrated Access and Wireless Backhaul (IAB) handover of a parent IAB node in an inter-Central Unit (inter-CU) migration.

According to certain embodiments, a method is performed by a target Central Unit (CU) during a handover of a migrating node from source CU and source Distributed Unit (DU) to the target CU and a target DU. The method includes transmitting, to the migrating node via the target DU, a first handover command for at least one child node of the migrating node being handed over from the source CU and source DU to the target CU and target DU.

According to certain embodiments, a method is performed by a migrating node during a handover from a source CU and a source DU to a target CU and a target DU. The method includes receiving, via the source CU, a first handover command from the target CU. The first handover command is for at least one child node of the migrating node being handed over from the source CU and source DU to the target CU and target DU. The migrating node transmits the message to the at least one child node.

According to certain embodiments, a method is performed by a migrating node during a handover from a source CU and source DU to a target CU and target DU. The migrating node is a child node of a parent migrating node, and the migrating node is a parent node to at least one additional child node. The method includes receiving, via the parent migrating node, a first handover command from the target CU. The first handover command is for the at least one additional child node that is being handed over from the source CU and source DU to the target CU and target DU with the migrating node. The migrating node transmits the message to the at least one additional child node of the migrating node.

According to certain embodiments, a target CU includes processing circuitry configured, during a handover of a migrating node from source CU and source DU to the target CU and a target DU, to transmit, to the migrating node via the target DU, a first handover command for at least one child node of the migrating node being handed over from the source CU and source DU to the target CU and target DU.

According to certain embodiments, a migrating node includes processing circuitry configured, during a handover from a source CU and a source DU to a target CU and a target DU, to receive, via the source CU, a first handover command from the target CU. The first handover command is for at least one child node of the migrating node being handed over from the source CU and source DU to the target CU and target DU. The processing circuitry is configured to transmit the message to the at least one child node.

According to certain embodiments, a migrating node includes processing circuitry configured to operate during a handover from a source CU and source DU to a target CU and target DU. The migrating node is a child node of a parent migrating node, and the migrating node is a parent node to at least one additional child node. The processing circuitry is configured to receive, via the parent migrating node, a first handover command from the target CU. The first handover command is for the at least one additional child node that is being handed over from the source CU and source DU to the target CU and target DU with the migrating node. The processing circuitry is configured to transmit the message to the at least one additional child node of the migrating node.

Certain embodiments may provide one or more of the following technical advantages. For example, particular embodiments include signaling enhancements to facilitate the handover of an IAB node and associated UEs and IAB node, specifically on the communication of the handover command to the IAB-MTs and UEs. Particular embodiments do so in an optimal way where it is not required to send the handover command one by one to each UE and IAB node, thereby reducing the total handover/relocation delay of an IAB node and its associated UEs, potentially preventing performance degradation to the active traffic of the concerned UEs.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a high-level architectural view of an example IAB network;

FIG. 2 illustrates the baseline user plane protocol stack for IAB;

FIG. 3 illustrates the baseline control plane protocol stack for IAB;

FIG. 4 illustrates an example functional view of the BAP sublayer;

FIG. 5 illustrates an example of some possible IAB-node migration cases listed in the order of complexity;

FIG. 6 illustrates an example IAB intra-CU topology adaptation procedure;

FIG. 7 an example IAB network scenario;

FIGS. 8A and 8B illustrate an example diagram for the signaling of handover commands, according to certain embodiments;

FIG. 9 illustrates an example wireless network, according to certain embodiments;

FIG. 10 illustrates an example network node, according to certain embodiments;

FIG. 11 illustrates an example wireless device, according to certain embodiments;

FIG. 12 illustrate an example user equipment, according to certain embodiments;

FIG. 13 illustrates a virtualization environment in which functions implemented by some embodiments may be virtualized, according to certain embodiments;

FIG. 14 illustrates a telecommunication network connected via an intermediate network to a host computer, according to certain embodiments;

FIG. 15 illustrates a generalized block diagram of a host computer communicating via a base station with a user equipment over a partially wireless connection, according to certain embodiments;

FIG. 16 illustrates a method implemented in a communication system, according to one embodiment;

FIG. 17 illustrates another method implemented in a communication system, according to one embodiment;

FIG. 18 illustrates another method implemented in a communication system, according to one embodiment;

FIG. 19 illustrates another method implemented in a communication system, according to one embodiment;

FIG. 20 illustrates a method by a target CU during a handover of a migrating node from a source CU and source DU to the target CU and target DU, according to certain embodiments;

FIG. 21 illustrates an example virtual apparatus, according to certain embodiments;

FIG. 22 illustrates a method by a migrating node during a handover from a source CU and a source DU to a target CU and a target DU, according to certain embodiments;

FIG. 23 illustrates another example virtual apparatus, according to certain embodiments;

FIG. 24 illustrates a method by a migrating node during a handover from a source CU and source DU to a target CU and target DU, according to certain embodiments; and

FIG. 25 illustrates another example virtual apparatus, according to certain embodiments.

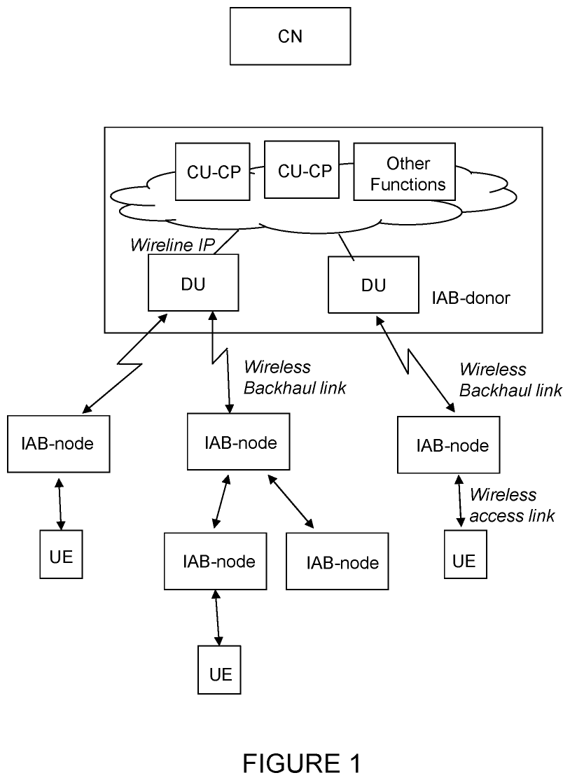

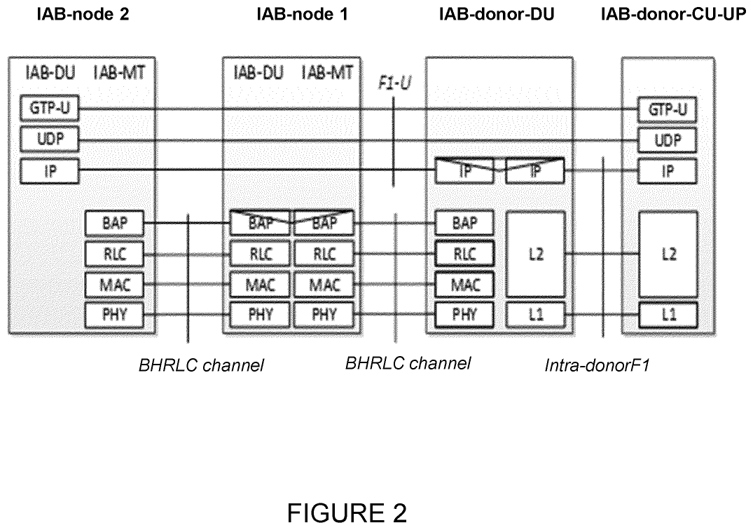

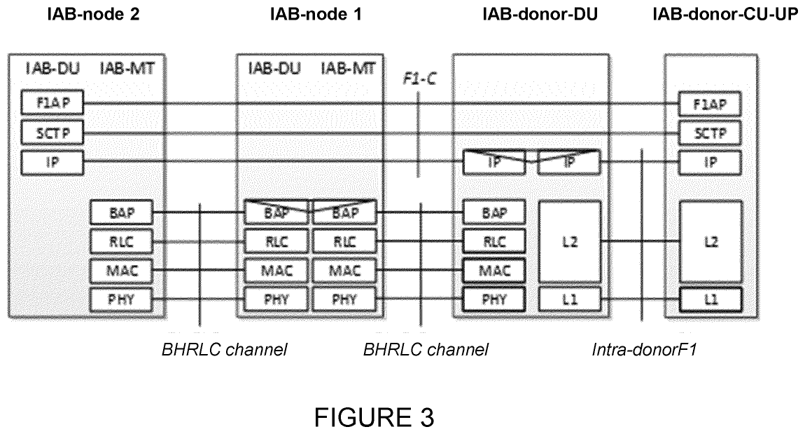

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As described herein, the inter-CU IAB node migration may be caused by e.g. radio link failure (RLF), load balancing, IAB node mobility. These are non-limiting examples. The terms migration, handover and mobility are used interchangeably, The terms “gNB-CU” and “Donor-CU”, “CU-CP” and “CU” are used interchangeably. All considerations for a split donor (i.e., donor CU) are equally applicable for a non-split donor (i.e., donor gNB).

The term “gNB” applies to all variants therein, e.g. “gNB”, “en-gNB” etc. The term “a UE/IAB node directly served by the migrating IAB node” refers to a UE/IAB node that is directly connected to the migrating IAB node. The term “a UE/IAB node is indirectly served by the migrating IAB node” means that the migrating IAB node is an ancestor node to an IAB node that is currently serving the UE or IAB node. The term concerned UE/IAB node refers to a UE/IAB node that is directly/indirectly being served by the migrating IAB node.

Though certain embodiments are described herein from an IAB network perspective, all embodiments, including those such as group signalling of handover commands and reconfiguration complete message (via DL and UL RRC message transfer like messages, respectively), are also applicable to a non-IAB scenario, where for example in a CU/DU split case the UEs are directly connected to the DU.

Certain embodiments disclosed herein relate to the signaling of the handover commands to the IAB nodes' MTs and UEs that are impacted by the Integrated Access and Wireless Backhaul (IAB) handover of a parent IAB node in an inter-CU migration. Specifically, particular embodiments include a layered or stepped approach whereby the target CU prepares the handover command (i.e. RRC Reconfiguration containing reconfigurationWithSync) for each concerned UE and IAB-MT, but includes only the handover command for the IAB-MT in the handover request acknowledgement message. After the handover of the IAB-MT is complete, the target CU then sends an F1-AP message including all the handover commands of the UEs under the IAB node that has just been handed over, as well the handover commands for the children IAB-MTs. When the children IAB-MTs have been handed over, the same procedure is applied, until all the hops have been addressed and all UEs and IAB-MTs are handed over.

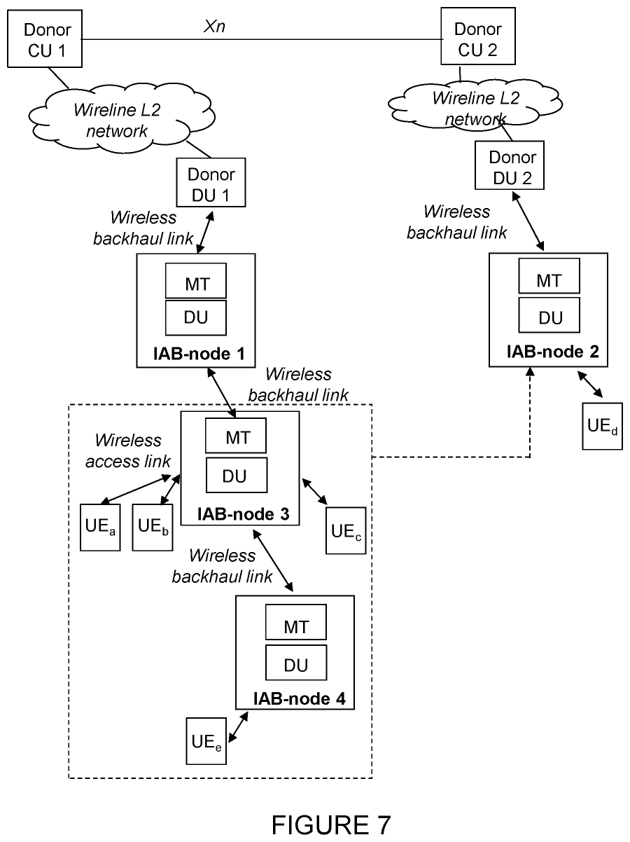

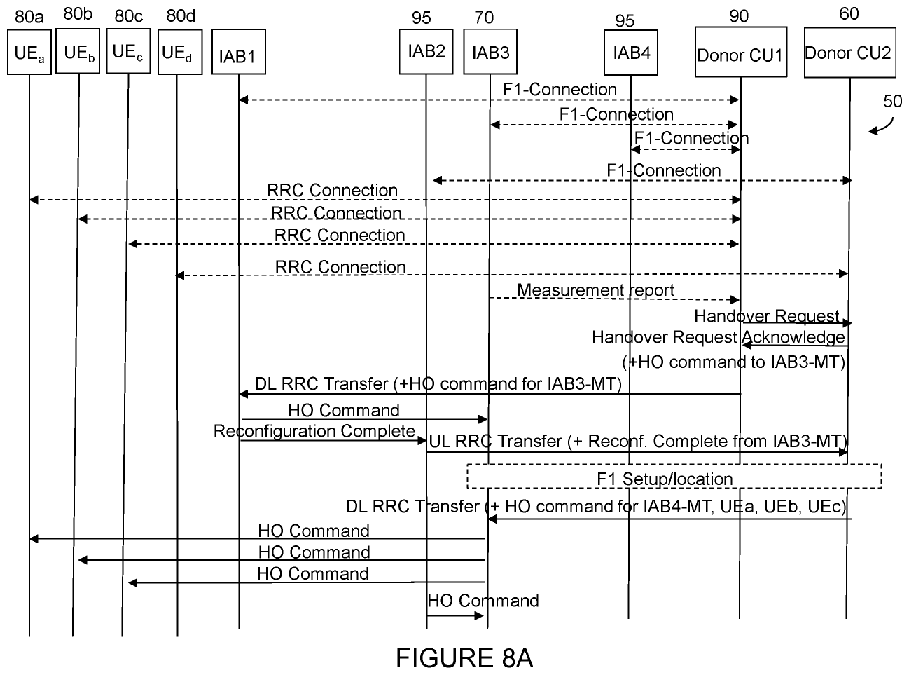

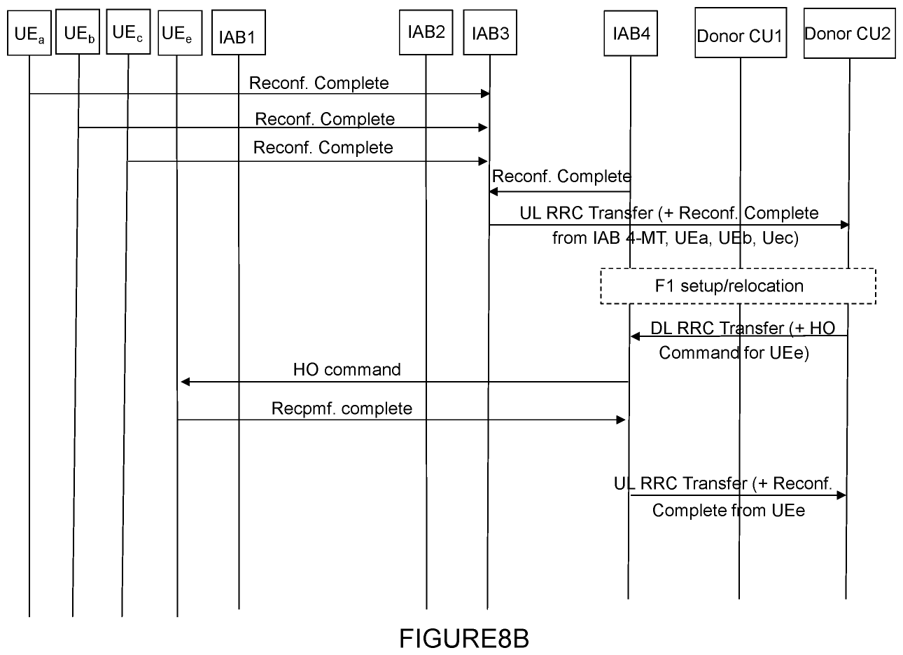

FIGS. 8A and 8B illustrate an example signaling diagram 50 of handover commands, according to certain embodiments disclosed herein. For example, according to certain embodiments, a target CU or a target Donor-CU 60 in an IAB network, which serves as a candidate donor node for an IAB node 70 (migrating IAB node) and provides connectivity for a UE 80a, 80b, 80c, 80d, performs one or more of the following steps:
1. Receiving a HANDOVER REQUEST-like message (either an enhanced version of the legacy Xn message or a new message for IAB handover) from a source CU or source donor CU 90 that includes the contexts of the first migrating IAB node 70 and the UEs 80a-d and IAB nodes 95 that are directly or indirectly served by the first migrating IAB node.
2. Performing admission control for the UEs and IAB nodes included in the handover request.
3. Preparing a handover command (i.e. RRC Reconfiguration With sync) to each UE and IAB node that is affected by the migration. For the example scenario of FIG. 7, this includes the MT's of IAB3 and IAB4 and UEs a, b, c and e.
4. Preparing and sending a HANDOVER REQUEST ACKNOWLEDGE-like message (either an enhanced version of the legacy Xn message or a new message for IAB handover) to the source CU. The HANDOVER REQUEST ACKNOWLEDGE-like message includes the list of admitted and not admitted PDU session resources that are associated with the concerned UEs and IAB nodes and contains the HandoverCommand only for the MT of the first migrating IAB node, which directly or indirectly serves all the UEs and other IAB nodes included in the HANDOVER REQUEST. In the example scenario of FIG. 7, the message only includes the HandoverCommand for IAB3-MT.
   Applying the legacy handover principles directly to this scenario would have resulted in the target CU including, in separate messages, all the handover commands for all the UEs/IAB nodes that are directly or indirectly being served by the IAB node (i.e. one HandoverCommand per each concerned UE/MT each sent in a separate HANDOVER REQUEST ACKNOWLEDGE) message.
5. Receiving an RRC Reconfiguration Complete message from the migrating IAB node's MT (IAB-3 MT).
6. Setting up/relocating the F1 connection between the migrating IAB node and the first network node.
7. Sending the prepared handover command for the UEs/IAB nodes directly under the migrating IAB node (e.g., UE a, b, c and IAB4-MT for the scenario in FIG. 7) using an F1-AP DL RRC transfer like message.
   In some embodiments, the legacy message is used. As such, one message may be sent for each served UE and child IAB node.
   In some embodiments, the F1-AP DL RRC transfer message is enhanced or a new message is introduced (e.g., F1-AP IAB DL RRC Transfer message, F1-AP group DL RRC Transfer message) to include several RRC messages that are destined for several UEs/IAB-MTs (i.e., including the F1-AP UE/IAB-MT identities and corresponding handover command, i.e., RRC Reconfiguration including reconfigurationWithSync).
      Additionally, an indication can be made for a group RRC delivery status request in the group DL transfer message.
   According to certain embodiments, a delivery status is sent by the DU to the CU in a CU/DU split architecture when the DU has successfully transmitted the message to the UE (from lower layer, i.e. PHY-MAC-RLC perspective), while the reconfiguration complete message from the UE signifies that the UE has successfully decoded/compiled/applied the RRC message).
8. Considering, in a layered approach, each child IAB node to which the handover command was sent to in step 7 as the migrating IAB node.
9. Repeating steps 5 to 8 for each IAB node considered as migrating IAB node in step 8. For each hop/layer of the IAB network, and until all the UEs and IAB nodes that are directly or indirectly served by the first migrating IAB node are properly handed over (i.e. each prepared handover command is sent to each UE/IAB-MT, the F1 connection of each directly/indirectly served IAB node is relocated to the target CU, and reconfiguration complete message corresponding to each handover command is received). For the step corresponding to step 5 (i.e., receiving the compete message):
   In some embodiments, receiving the RRC reconfiguration complete message each UE/IAB-MT under the migrating IAB node in separate UL RRC Transfer message, i.e. as in legacy CU/DU split architecture.
   In some embodiments, receiving a modified or newly defined UL RRC transfer message like message, that contains the RRC reconfiguration complete message for more than one UE or IAB-MT (up to all the UEs/IAB-MTs under the migrating IAB node).
   In some embodiments, instead of waiting for the complete message from an IAB-MT before sending the handover command corresponding to the UEs/children IAB nodes under that IAB node, a reception of the RRC delivery status corresponding to that MT's handover command is considered to the trigger to prepare and send the group DL transfer message towards that IAB node.

Certain other embodiments include steps for migrating an IAB node being handed over to a target CU or target donor CU from a source CU or source donor CU). For example, according to certain embodiments, the steps may include one or more of the following:
1. Receiving an F1-AP message from the target CU, via the source CU, which contains the handover commands for the multitude of UEs and child IAB nodes that are being served by the migrating IAB node (i.e., UE/IAB-MT identifications as well the handover commands, RRC Reconfiguration including a reconfigurationWithSync), wherein the F1-AP message is:
   an enhanced version of the F1-AP DL RRC Transfer message, or
   a new message introduced for the purpose of this group signaling (e.g., F1-AP IAB DL RRC Transfer message, F1-AP group DL RRC Transfer message, etc.).
2. Forwarding the handover command to the corresponding UE/child IAB-MT.
3. Receiving an RRC Reconfiguration complete message from each UE/child IAB-MT.
4. Transferring the RRC Reconfiguration complete message to the target CU.
   In some embodiments, a separate legacy F1-AP UL RRC Transfer message is employed to transfer each message.
      In a particular embodiment, for example, the legacy F1-AP UL RRC Transfer message is enhanced or a new F1-AP message is defined (e.g., F1-AP IAB UL RRC Transfer message, F1-AP group UL RRC Transfer message), which is used to include the RRC Reconfiguration complete messages of a multitude of UEs/child IAB-MTs (up to all the UEs/child IAB-MTs directly served by the migrating IAB node).
         The migrating IAB node can wait to receive the complete message from each of its UEs/children IAB-MTs, before generating the group UL RRC transfer message.
         The migrating IAB node waits for a certain duration, based on a configured timer value (e.g., based on network implementation, specified in the standards, configure via OAM, etc.), and includes all the complete messages that it has received during that time in the group UL RRC transfer message (the complete messages that are received after this time can be sent separately one by one, or the IAB node waits for another duration equivalent to the configured timer or another timer value and compiles another group message, and so on).

According to certain embodiments, a similar approach as step 4 above is taken for sending a group RRC Delivery Status message. For example, if the received group DL RRC Transfer message includes a request for group RRC Delivery status indication, the IAB node will send one group RRC Delivery status message that aggregates the delivery status for each concerned UE/IAB-MT. The same considerations like for the group UL RRC Transfer message can be made (i.e. waiting for all the RRC messages of all the UEs/IAB-MTs to be transmitted properly before compiling the group delivery status message, waiting for a certain duration, etc.).

The group signaling enhancements proposed in the above embodiments (e.g., modified or new F1AP DL/UL RRC transfer like messages) carrying info to/from multiple UEs and IAB-MTs can be generalized to carry any other message (e.g., a non-handover RRC message, i.e., not containing reconfigurationWithSync, or even non RRC message like a NAS message). Also, though the examples described herein are for the IAB scenario, the concept can be reused even in a non IAB scenario (e.g., CU/DU split architecture where UEs are directly under the DU), to enable efficient group signaling via non UE associated messages instead of sending messages one by one to/from each UE.

For the handover scenario illustrated in FIG. 7, the following signaling diagram exemplifies the embodiments. In the illustrated signaling diagram, the “+HO command to IAB3-MT” refers to the contents (as an OCTET STRING) in the “Target NG-RAN node To Source NG-RAN node Transparent Container” IE of the message. The DL RRC transfer message sent from CU1 to IAB1 is also the legacy DL RRC transfer message. The “+HO command to IAB3-MT” refers to the contents (as an OCTET STRING) in the “RRC-Container” IE of the message.

The following are example messages used in some embodiments. One is an example of a new non-UE associated F1AP IAB DL RRC MESSAGE TRANSFER message that carries the HandoverCommand for multiple UEs/IAB-MTs. In a particular embodiment, the DL RRC messages for the concerned UEs and IAB-MTs are carried as the items of the same unified list within the F1AP IAB DL RRC MESSAGE TRANSFER message (the example below refers to this embodiment). In some embodiments, there are separate lists for the concerned UEs and the concerned IAB-MTs within the F1AP IAB DL RRC MESSAGE TRANSFER message.

Another example is a new non-UE associated F1AP IAB UL RRC MESSAGE TRANSFER message that carries the RRCReconfigurationComplete message from multiple UEs/IAB-MTs. In a particular embodiment, the UL RRC messages for the concerned UEs and IAB-MTs are carried as the items of the same unified list within the F1AP IAB UL RRC MESSAGE TRANSFER message (the example below refers to this embodiment). In a particular embodiment, there are separate lists for the concerned UEs and the concerned IAB-MTs within the F1AP IAB UL RRC MESSAGE TRANSFER message.

Another example is a new F1AP IAB RRC Delivery Report, carrying the RRC DL message delivery status for one or more IAB-MTs and/or UEs. The message may carry delivery status indication for each concerned IAB-MT and/or UE individually or it may carry a single IE that indicates that all DL RRC messages are delivered successfully.

The information carried in this message may pertain only to the UEs and IAB-MTs that are directly served by the IAB node receiving this F1AP message.

The IAB DL RRC MESSAGE TRANSFER non-UE associated message is sent by the IAB-donor-CU to transfer to the IAB-DU the layer 3 messages pertaining to one or more IAB-MTs and/or UEs, directly served by the IAB-DU. The direction of the message is from IAB-donor-CU to IAB-DU. However, as described above, this message could be generalized to be from any CU to any DU in such as, for example, a non IAB case. The same may be true and applicable for all the example messages described above.

Table 14 summarizes the elements of an example IAB DL RRC MESSAGE TRANSFER.

TABLE 14

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| Transaction ID | M | | 9.3.1.23 | | YES | reject |
| Group RRC | O | | ENUMERATED | Indicates whether | YES | ignore |
| Delivery Status | | | (true, ...) | RRC DELIVERY | | |
| Request Required | | | | REPORT for a | | |
| | | | | group of IAB- | | |
| | | | | MTs and/or UEs | | |
| | | | | is requested. | | |
| Directly Served | | 1 | | The list of child | | |
| IAB-MT or UE | | | | IAB nodes and/or | | |
| List | | | | UEs directly | | |
| | | | | served by the | | |
| | | | | IAB-DU. | | |
| >Directly | | 1.. <max- | | | | |
| Served IAB- | | number- | | | | |
| MT/UE List | | ofserved- | | | | |
| Item | | MTsor- | | | | |
| | | UEs> | | | | |
| >>gNB-CU | M | | 9.3.1.4 | | YES | reject |
| UE F1AP ID | | | | | | |
| >>gNB-DU | M | | 9.3.1.5 | | YES | reject |
| UE F1AP ID | | | | | | |
| >>SRB ID | M | | 9.3.1.7 | | YES | reject |
| >>RRC- | M | | 9.3.1.6 | Includes the DL- | YES | reject |
| Container | | | | DCCH-Message | | |
| | | | | IE as defined in | | |
| | | | | subclause 6.2 of | | |
| | | | | TS 38.331 [8] | | |
| | | | | encapsulated in a | | |
| | | | | PDCP PDU, or | | |
| | | | | the DL-CCCH- | | |
| | | | | Message IE as | | |
| | | | | defined in | | |
| | | | | subclause 6.2 of | | |
| | | | | TS 38.331 [8]. | | |
| >>old gNB- | O | | 9.3.1.5 | | YES | reject |
| DU UE F1AP | | | | | | |
| ID | | | | | | |
| >>Execute | O | | ENUMERATED | | YES | ignore |
| Duplication | | | (true, ...) | | | |
| >>RAT- | O | | 9.3.1.34 | | YES | reject |
| Frequency | | | | | | |
| Priority | | | | | | |
| Information | | | | | | |
| >>RRC | O | | ENUMERATED | Indicates whether | YES | ignore |
| Delivery | | | (true, ...) | RRC DELIVERY | | |
| Status Request | | | | REPORT | | |
| | | | | procedure is | | |
| | | | | requested for the | | |
| | | | | RRC message. | | |
| >>UE Context | O | | ENUMERATED | | YES | reject |
| not retrievable | | | (true, ...) | | | |
| >>Redirected | O | | RRC | Includes the UL- | YES | reject |
| RRC message | | | Container | DCCH-Message | | |
| | | | 9.3.1.6 | IE as defined in | | |
| | | | | subclause 6.2 of | | |
| | | | | TS 38.331 [8], | | |
| | | | | encapsulated in a | | |
| | | | | PDCP PDU. | | |
| >>PLMN | O | | PLMN | | YES | ignore |
| Assistance | | | Identity | | | |
| Info for | | | 9.3.1.14 | | | |
| Network | | | | | | |
| Sharing | | | | | | |
| >>New gNB- | O | | gNB-CU | | YES | reject |
| CU UE F1AP | | | UE F1AP ID | | | |
| ID | | | 9.3.1.4 | | | |
| >>Additional | O | | 9.3.1.90 | | YES | ignore |
| RRM Policy | | | | | | |
| Index | | | | | | |

The Group RRC Delivery Status Request Required IE tells the DU whether the group RRC delivery status indication is preferred. This one can be as the alternative to the RRC Delivery Status Request IE (which is per UE/MT). For example, if all deliveries are ok, then the group ACK can be used instead of individual acks.

Some IEs, such as the Additional Radio Resource Management (RRM) Policy Index for example, may be signaled at the top level (i.e., same value for all UEs/IAB-MTs).

The IAB UL RRC MESSAGE TRANSFER non-UE associated message is sent by the IAB-DU to transfer to the IAB-donor-CU the layer 3 messages pertaining to one or more IAB-MTs and/or UEs directly served by the IAB-DU. The direction of this message is from the IAB-DU to the IAB-donor-CU. Table 15 summarizes the elements of an example IAB UL RRC MESSAGE TRANSFER non-UE associated message.

TABLE 15

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| Transaction ID | M | | 9.3.1.23 | | YES | reject |
| Directly Served | | 1 | | The list of child | | |
| IAB-MT or UE | | | | IAB nodes and/or | | |
| List | | | | UEs directly | | |
| | | | | served by the | | |
| | | | | IAB-DU. | | |
| >Directly | | 1.. <max- | | | | |
| Served IAB-MT | | number- | | | | |
| or UE List Item | | ofserved- | | | | |
| | | MTsor- | | | | |
| | | UEs> | | | | |
| >>gNB-CU | M | | 9.3.1.4 | | YES | reject |
| UE F1AP ID | | | | | | |
| >>gNB-DU | M | | 9.3.1.5 | | YES | reject |
| UE F1AP ID | | | | | | |
| >>SRB ID | M | | 9.3.1.7 | | YES | reject |
| >>RRC- | M | | 9.3.1.6 | Includes the DL- | YES | reject |
| Container | | | | DCCH-Message | | |
| | | | | IE as defined in | | |
| | | | | subclause 6.2 of | | |
| | | | | TS 38.331 [8] | | |
| | | | | encapsulated in a | | |
| | | | | PDCP PDU, or | | |
| | | | | the DL-CCCH- | | |
| | | | | Message IE as | | |
| | | | | defined in | | |
| | | | | subclause 6.2 of | | |
| | | | | TS 38.331 [8]. | | |
| >>Selected | O | | PLMN | | YES | reject |
| PLMN ID | | | Identity | | | |
| | | | 9.3.1.14 | | | |
| >>New gNB- | O | | gNB-DU | | YES | reject |
| DU UE F1AP | | | UE F1AP | | | |
| ID | | | ID | | | |
| | | | 9.3.1.5 | | | |

The IAB RRC DELIVERY REPORT message is sent by the IAB-DU to inform the IAB-donor-CU about the delivery status of DL RRC messages for one or more IAB-MTs and/or UEs directly served by the IAB-DU. The direction of this message is from IAB-DU to IAB-donor-CU. Table 16 summarizes the elements of an example IAB RRC DELIVERY REPORT message.

TABLE 16

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| Transaction ID | M | | 9.3.1.23 | | YES | reject |
| CHOICE Group or | | | | | | |
| Detailed RRC | | | | | | |
| delivery status | | | | | | |
| report | | | | | | |
| >Group RRC | M | | 9.3.1.71 | | YES | ignore |
| Delivery Status | | | | | | |
| >Individual RRC | M | | | | | |
| Delivery Status | | | | | | |
| >>Directly | | 0..1 | | The list of child | | |
| Served IAB- | | | | IAB nodes and/or | | |
| MT or UE List | | | | UEs directly | | |
| | | | | served by the IAB- | | |
| | | | | DU. | | |
| >>>Directly | | 1.. <max- | | | | |
| Served IAB- | | number- | | | | |
| MT or UE | | ofserved- | | | | |
| List Item | | MTsor- | | | | |
| | | UEs> | | | | |
| >>>>gNB- | M | | 9.3.1.4 | | YES | reject |
| CU UE | | | | | | |
| F1AP ID | | | | | | |
| >>>>gNB- | M | | 9.3.1.5 | | YES | reject |
| DU UE | | | | | | |
| F1AP ID | | | | | | |
| >>>>RRC | M | | 9.3.1.71 | | YES | ignore |
| Delivery | | | | | | |
| Status | | | | | | |
| >>>>SRB | M | | 9.3.1.7 | | YES | ignore |
| ID | | | | | | |

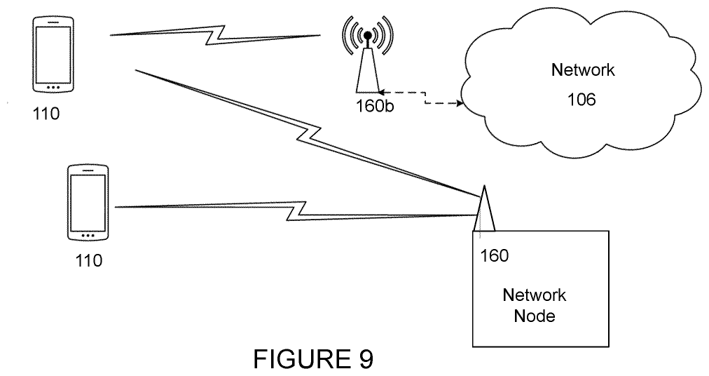

FIG. 9 illustrates a wireless network in accordance with some embodiments. Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

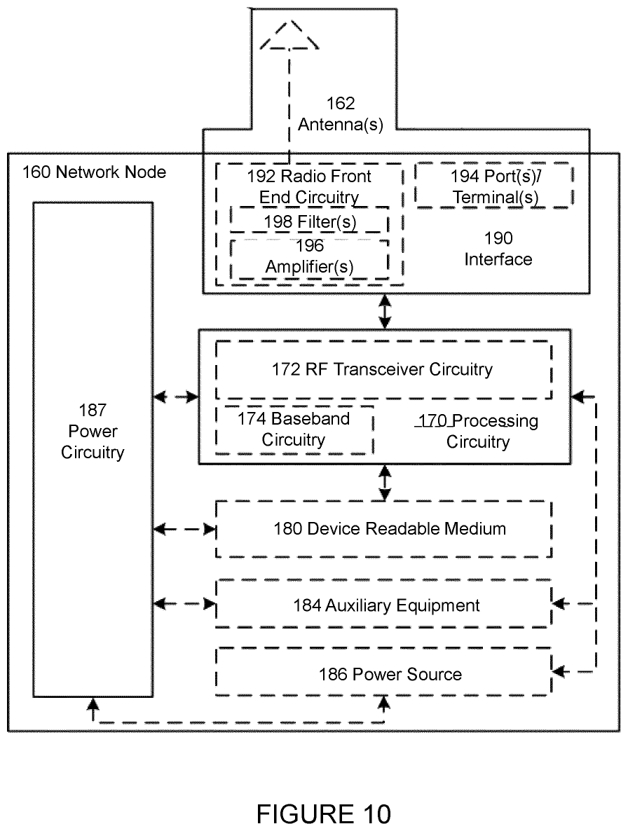

FIG. 10 illustrates an example network node, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs)), Operation and Maintenance (O&M) nodes, Operations Support System (OSS) nodes, Self Optimized Network (SON) nodes, positioning nodes (e.g., Evolved-Serving Mobile Location Centres (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 160 includes processing circuitry 170, device readable medium 180, interface 190, auxiliary equipment 184, power source 186, power circuitry 187, and antenna 162. Although network node 160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may′ comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair may in some instances be considered a single separate network node. In some embodiments, network node 160 may be configured to support multiple radio access technologies (RATs). In such embodiments, some components may′ be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, Wideband Code Division Multiplexing Access (WCDMA), LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 10 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

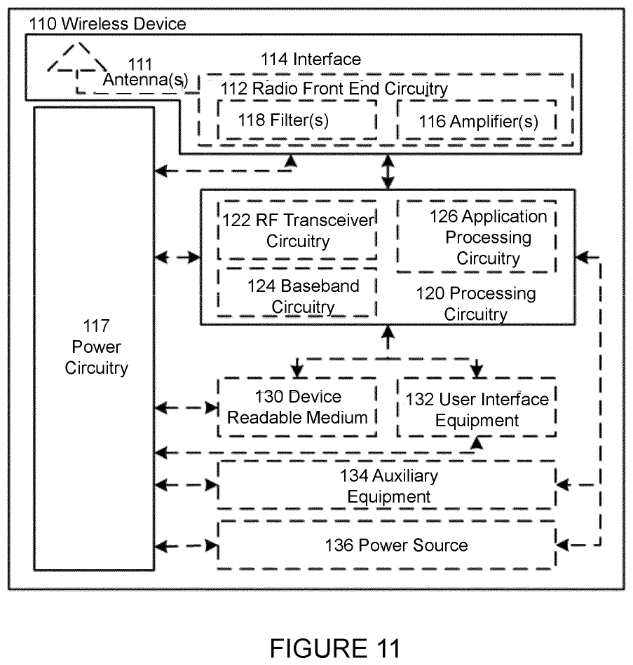

FIG. 11 illustrates an example wireless device 110, according to certain embodiments. As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

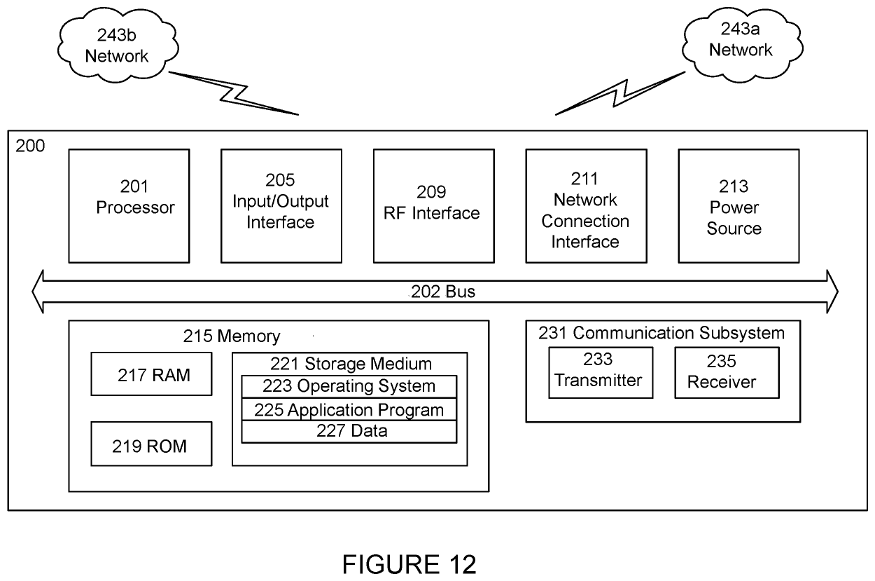

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethemet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 12, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

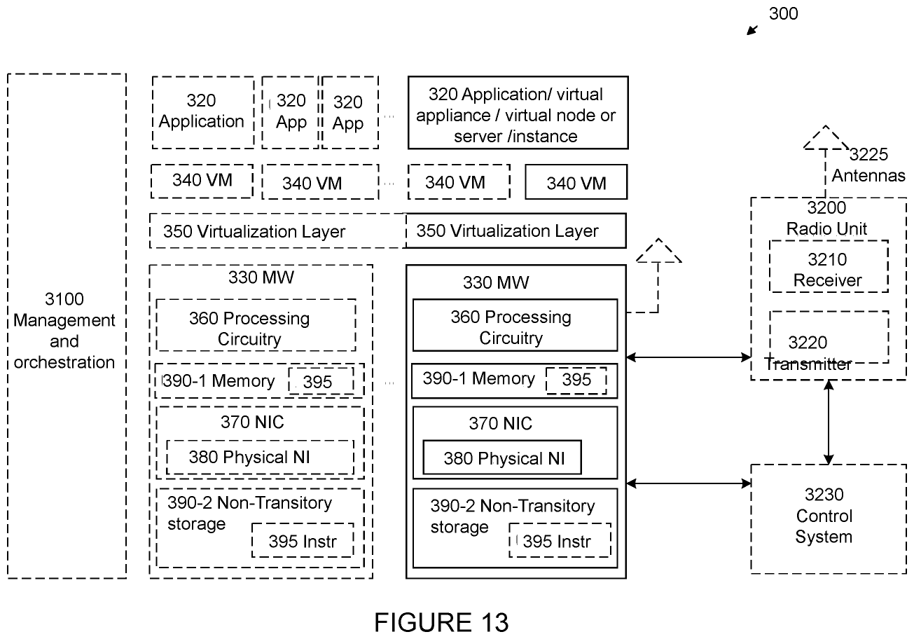

FIG. 13 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 13, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 13.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

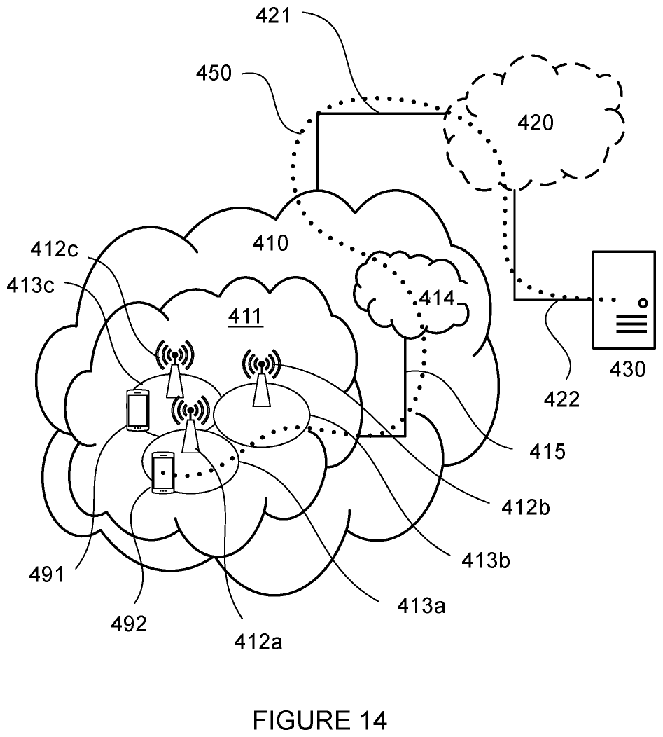

FIG. 14 illustrates a telecommunication network connected via an intermediate network to a host computer in accordance with some embodiments. With reference to FIG. 14, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

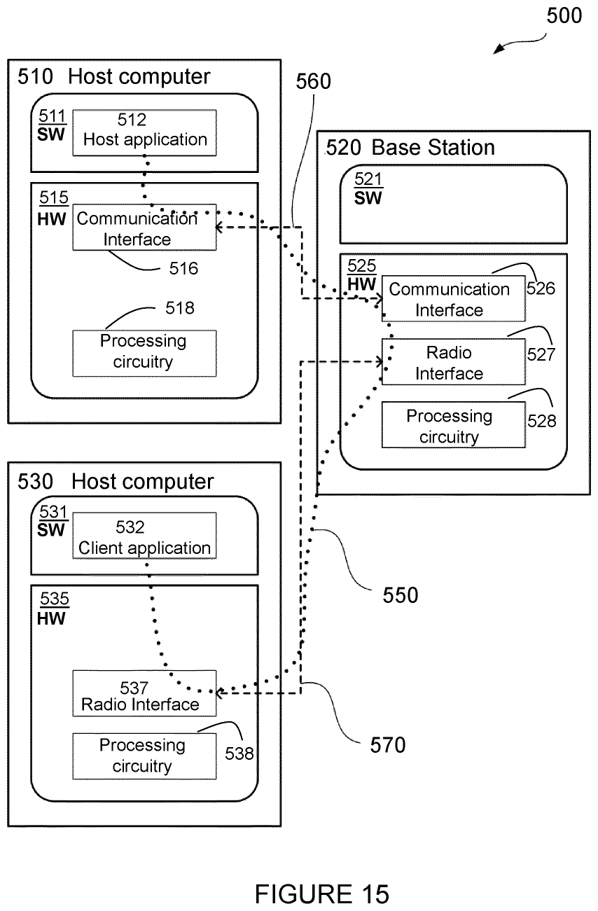

FIG. 15 illustrates a host computer communicating via a base station with a user equipment over a partially wireless connection in accordance with some embodiments. Example implementations, in accordance with an embodiment, of the UE, base station and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by base station 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 15 may be similar or identical to host computer 430, one of base stations 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

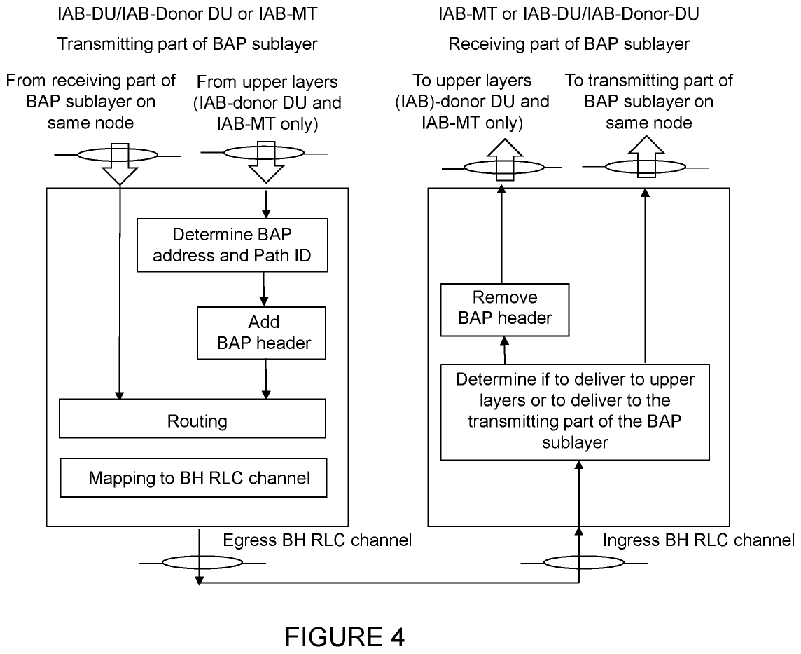

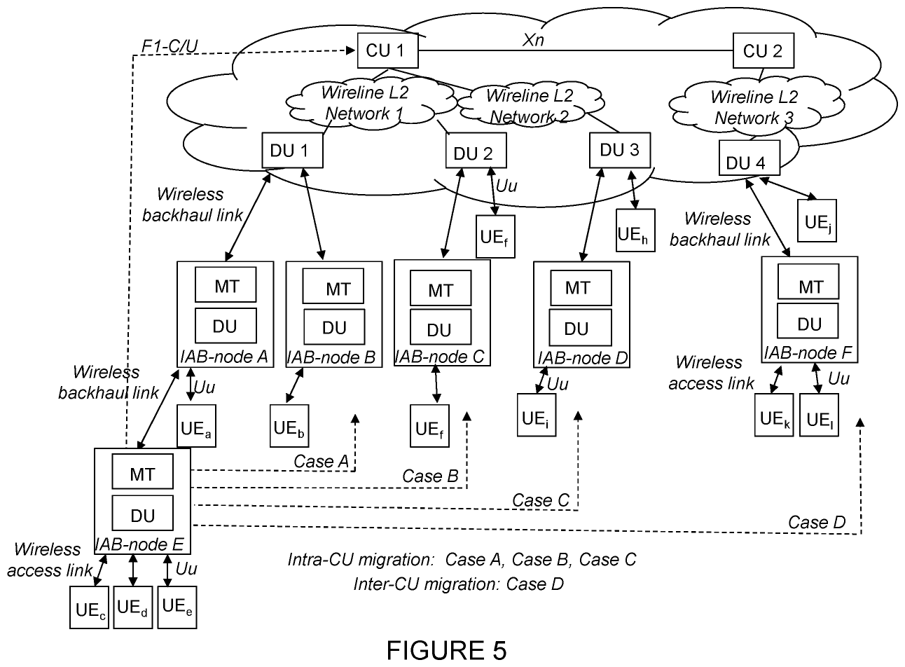

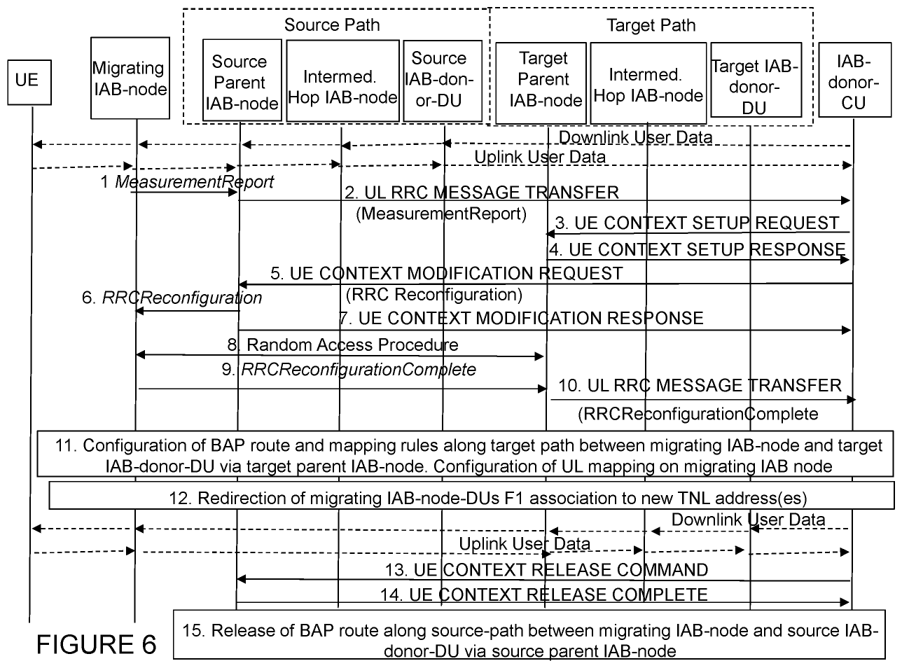

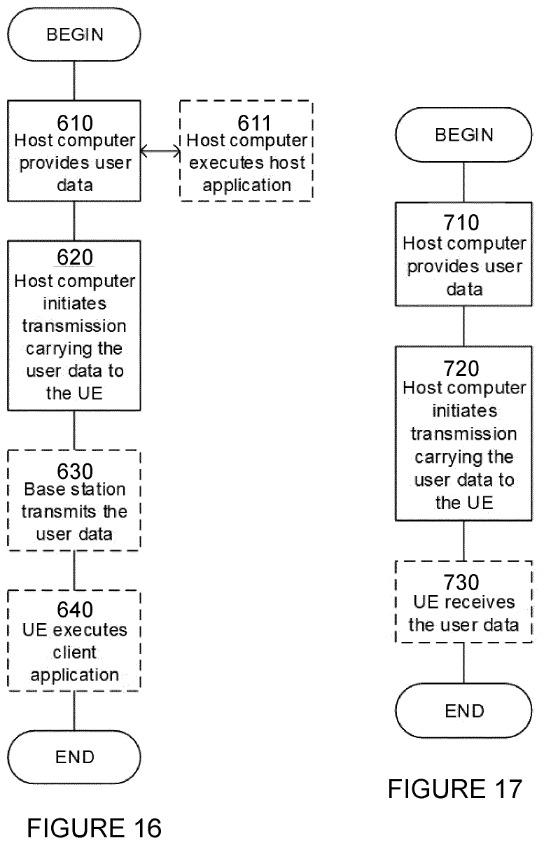

FIG. 16 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 16 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 17 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

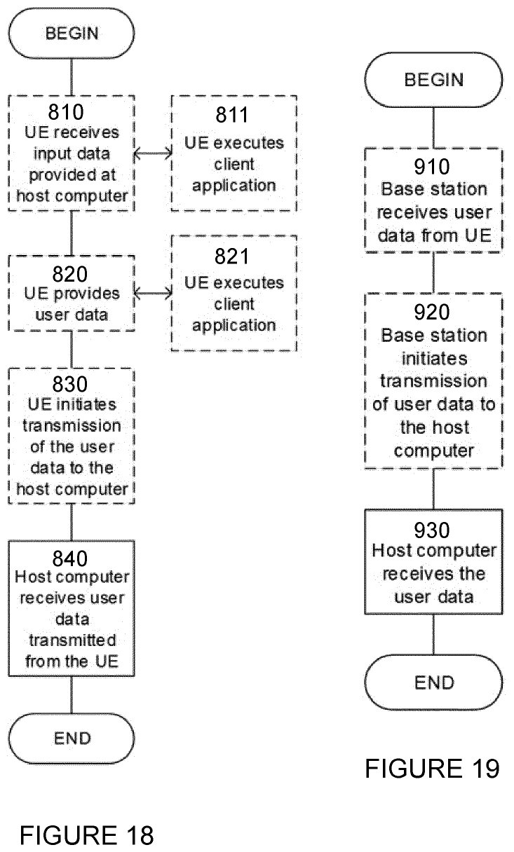

FIG. 18 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 18 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station and a UE which may be those described with reference to FIGS. 4 and 5. For simplicity of the present disclosure, only drawing references to FIG. 9 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

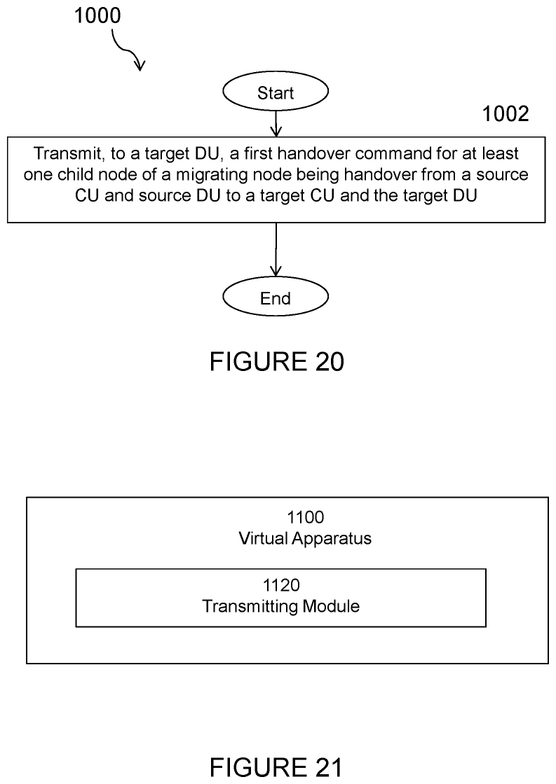

FIG. 20 depicts a method 1000 by a target CU during a handover of a migrating node from a source CU and source DU to the target CU and target DU, according to certain embodiments. At step 1002, the target CU transmits, to the target DU, a first handover command for at least one child node of the migrating node being handed over from the source CU and source DU to the target CU and target DU.

In a particular embodiment, the migrating node is an Integrated Access and Backhaul node, IAB node; the handover of the migrating node is an inter-CU IAB migration; the first CU is a first donor CU during the inter-CU IAB migration; the second CU is a second donor CU during the inter-CU IAB migration; and the target DU is a target donor DU.

In a particular embodiment, the target CU receives a handover request from the source CU, the handover request indicating the migrating node and the at least one child node for handover from the source CU to the target CU.

In a particular embodiment, the target CU transmits, to the migrating node via the source CU, a handover request acknowledgment message. The handover request acknowledgement message comprises a second handover command for only the migrating node, and the handover request acknowledgement message is transmitted to the migrating node before the first handover command is transmitted to the at least one child node.

In a particular embodiment, prior to transmitting the first handover command; the target CU receives, from an MT of the migrating node, an RRC Reconfiguration Complete message and sets up an F1 connection between the migrating node and the target CU.

In a particular embodiment, the first handover command comprises a F1-AP DL RRC transfer message.

In a particular embodiment, the first handover command comprises a plurality of messages, and each one of the plurality of messages is for a particular one of a plurality of child nodes of the migrating node being handed over from the source CU and source DU to the target CU and target DU.

In a particular embodiment, the first handover command comprises a request for a group RRC delivery status.

In a particular embodiment, the target CU receives at least reconfiguration complete message from the at least one child node, and the at least one response message indicates that the at least one child node received the first handover command.

In a particular embodiment, the first handover command transmitted to the migrating node initiates the only handover command for the at least one child node of the migrating node.

In a particular embodiment, at least one child node of the migrating node comprises a child IAB node that is a parent with respect to at least one additional child node, and the target CU transmits a third handover command for the at least one additional child node that is handed over from the first CU to the second CU with the child IAB node.

In a particular embodiment, prior to transmitting the third handover command, the target CU receives, from an MT of the child IAB node, an RRC Reconfiguration Complete message and sets up an F1 connection between the child IAB node and the first network node.

FIG. 21 illustrates a schematic block diagram of a virtual apparatus 1100 in a wireless network (for example, the wireless network shown in FIGURE A). The apparatus may be implemented in a wireless device or network node (e.g., wireless device 110 or network node 160 shown in FIG. 9). Apparatus 1100 is operable to carry out the example method described with reference to FIG. 20 and possibly any other processes or methods disclosed herein. It is also to be understood that the method of FIG. 20 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1110 and any other suitable units of apparatus 1100 to perform corresponding functions according one or more embodiments of the present disclosure.

According to certain embodiments, transmitting module 1110 may perform certain of the transmitting functions of the apparatus 1100. For example, transmitting module 1110 may transmit, to the target DU, a first handover command for at least one child node of the migrating node being handed over from the source CU and source DU to the target CU and target DU.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

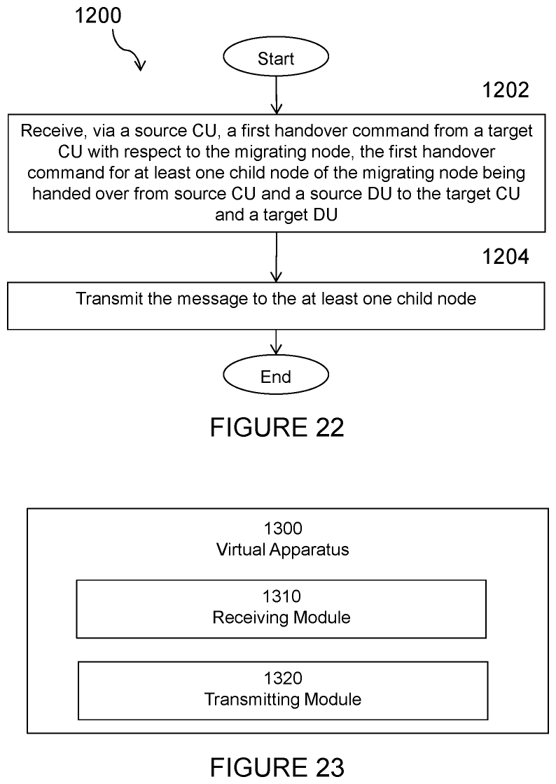

FIG. 22 depicts a method 1200 by a migrating node during a handover from a source CU and a source DU to a target CU and a target DU, according to certain embodiments. At step 1202, the migrating node receives, via the source CU, a first handover command from the target CU. The first handover command is for at least one child node of the migrating node being handed over from the source CU and source DU to the target CU and target DU. At step 1204, the migrating node transmits the message to the at least one child node.

In a particular embodiment, the migrating node is an IAB node; the handover from the source CU and source DU to the target CU and target DU is an inter-CU IAB migration; the source CU is a source donor CU during the inter-CU IAB migration; and the target CU is a source donor CU during the inter-CU IAB migration.

In a particular embodiment, prior to receiving the first handover command, the migrating node receives, via the source CU, a handover request acknowledgment message. The handover request acknowledgement message comprises a second handover command intended only for the migrating node.

In a particular embodiment, prior to receiving the second handover command, the migrating node transmits, via the source CU, an RRC Reconfiguration Complete message to the target CU, and an F1 connection is set up between the migrating node and the target CU based on the RRC Reconfiguration Complete message.

In a particular embodiment, the first handover command comprises a F1-AP DL RRC transfer message.

In a particular embodiment, the first handover command comprises a plurality of messages, and each one of the plurality of messages is for a particular one of a plurality of child nodes of the migrating node. The plurality of child nodes are being handed over from the source CU and source DU to the target CU and target DU with the migrating node.

In a particular embodiment, the first handover command comprises a request for a group RRC delivery status.

In a particular embodiment, the first handover command initiates the only handover command for the at least one child node of the migrating node.

In a particular embodiment, the migrating node receives at least one reconfiguration complete message from the at least one child node, and the at least one reconfiguration complete message indicates that the at least one child node received the first handover command. The migrating node transmits, to the target CU, the at least one reconfiguration complete message from the at least one child node.

In a particular embodiment, the at least one reconfiguration complete message comprises a plurality of reconfiguration complete messages, and each of the plurality of reconfiguration complete messages being from a particular one of a plurality of child nodes of the migrating node.

In a particular embodiment, each one of the plurality of reconfiguration complete messages is transmitted to the target CU in a separate F1-AP UL RRC Transfer message.

In a particular embodiment, the plurality of reconfiguration complete messages are transmitted to the target CU in a single F1-AP UL RRC Transfer message.

In a particular embodiment, the single F1-AP UL RRC Transfer message is transmitted after a duration of time associated with a timer.

In a particular embodiment, the migrating node receives, from the target CU, a request for group delivery of the plurality of reconfiguration complete messages.

In a particular embodiment, at least one child node of the migrating node comprises a child IAB node that is a parent with respect to at least one additional child node, and the migrating node receives a third handover command for the at least one additional child node being handed over from the source CU and source DU to the target CU and target DU with the child IAB node. The migrating node transmits the third handover command to the at least one additional child IAB node.

In a particular embodiment, prior to receiving the third handover command, the migrating node receives, from an MT of the at least one additional child IAB node, an RRC Reconfiguration Complete message and transmits, to the target CU, the RRC Reconfiguration Complete message to trigger setup of an F1 connection between the at least one additional child IAB node and the target CU.

FIG. 23 illustrates a schematic block diagram of a virtual apparatus 1300 in a wireless network (for example, the wireless network shown in FIG. 9). The apparatus may be implemented in a wireless device or network node (e.g., wireless device 110 or network node 160 shown in FIG. 9). Apparatus 1300 is operable to carry out the example method described with reference to FIG. 23 and possibly any other processes or methods disclosed herein. It is also to be understood that the method of FIG. 23 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310, transmitting module 1320, and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, via the source CU, a first handover command from the target CU. The first handover command is for at least one child node of the migrating node being handed over from the source CU and source DU to the target CU and target DU.

According to certain embodiments, transmitting module 1320 may perform certain of the transmitting functions of the apparatus 1300. For example, transmitting module 1320 may transmit the message to the at least one child node.

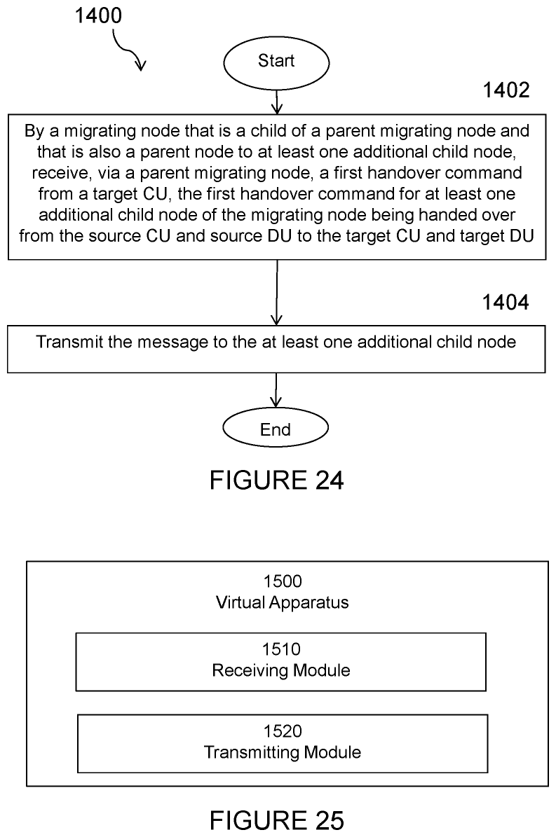

FIG. 24 depicts a method 1400 by a migrating node during a handover from a source CU and source DU to a target CU and target DU, according to certain embodiments. The migrating node is a child node of a parent migrating node, and the migrating node is a parent node to at least one additional child node. At step 1404, the migrating node receives, via the parent migrating node, a first handover command from the target CU. The first handover command is for the at least one additional child node of the migrating node, which is also being handed over from the source CU and source DU to the target CU and target DU with the migrating node. At step 1404, the migrating node transmits the message to the at least one additional child node of the migrating node.

In a particular embodiment, the migrating node and the parent migrating node are IAB nodes; the handover is an inter-CU IAB migration; the source CU is a source donor CU during the inter-CU IAB migration; and the target CU is a target donor CU during the inter-CU IAB migration.

In a particular embodiment, prior to receiving the first handover command, the migrating node receives; via the parent migrating node, a handover request acknowledgment message. The handover request acknowledgement message comprises a second handover command intended for the migrating node.

In a particular embodiment, prior to receiving the second handover command, the migrating node transmits, via the parent migrating node, an RRC Reconfiguration Complete message to the target CU. An F1 connection is set up between the migrating node and the target CU based on the RRC Reconfiguration Complete message.

In a particular embodiment, the first handover command comprises a F1-AP DL RRC transfer message.

In a particular embodiment, the migrating node is a parent node with respect to a plurality of child nodes being handed over from the source CU and source DU to the target CU and target DU with the migrating node; the first handover command comprises a plurality of messages; and each one of the plurality of messages for a particular one of the plurality of child nodes.

In a particular embodiment, the migrating node transmits, via the parent migrating node, at least one reconfiguration complete message to the target CU. The at least one reconfiguration complete message indicates that the migrating node received the first handover command.

In a particular embodiment, the migrating node is a parent node with respect to a plurality of child nodes being handed over from the source CU and source DU to the target CU and target DU with the migrating node. The at least one reconfiguration complete message comprises a plurality of reconfiguration complete messages, and each of the plurality of reconfiguration complete messages being from a particular one of the plurality of child nodes.

In a particular embodiment, each one of the plurality of reconfiguration complete messages is transmitted to the parent migrating node in a separate Radio Resource Control, RRC, message.

In a particular embodiment, the plurality of reconfiguration complete messages is transmitted to the parent migrating node in a single RRC message.

In a particular embodiment, the single RRC message is transmitted after a duration of time associated with a timer.

In a particular embodiment, the migrating node receives, from the parent migrating node, a request for group delivery of the plurality of reconfiguration complete messages.

FIG. 25 illustrates a schematic block diagram of a virtual apparatus 1500 in a wireless network (for example, the wireless network shown in FIG. 9). The apparatus may be implemented in a wireless device or network node (e.g., wireless device 110 or network node 160 shown in FIG. 9). Apparatus 1500 is operable to carry out the example method described with reference to FIG. 24 and possibly any other processes or methods disclosed herein. It is also to be understood that the method of FIG. 24 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1510, transmitting module 1520, and any other suitable units of apparatus 1500 to perform corresponding functions according one or more embodiments of the present disclosure.

According to certain embodiments, receiving module 1510 may perform certain of the receiving functions of the apparatus 1500. For example, receiving module 1510 may receive, via the parent migrating node, a first handover command from the target CU. The first handover command is for the at least one additional child node of the migrating node, which is also being handed over from the source CU and source DU to the target CU and target DU with the migrating node.

According to certain embodiments, transmitting module 1520 may perform certain of the transmitting functions of the apparatus 1500. For example, transmitting module 1520 may transmit the message to the at least one additional child node of the migrating node.

### EXAMPLE EMBODIMENTS

### Group A Example Embodiments

Example Embodiment 1. A method performed by a wireless device, the method comprising: any of the wireless device steps, features, or functions described above, either alone or in combination with other steps, features, or functions described above.

Example Embodiment 2. The method of the previous embodiment, further comprising one or more additional wireless device steps, features or functions described above.

Example Embodiment 3. The method of any of the previous embodiments, further comprising: providing user data; and forwarding the user data to a host computer via the transmission to the base station.

### Group B Embodiments

Example Embodiment 4. A method performed by a base station for handing over an IAB node from a first donor CU to a second donor CU during an inter-CU IAB migration, the method comprising: any of the steps, features, or functions described above with respect to embodiment group A, either alone or in combination with other steps, features, or functions described above.

Example Embodiment 5. A method performed by a base station for handing over an IAB node from a first donor CU to a second donor CU during an inter-CU IAB migration, the method comprising: any of the steps, features, or functions described above with respect to embodiment group B, either alone or in combination with other steps, features, or functions described above.

Example Embodiment 6. The method of any of the previous embodiments, further comprising: obtaining user data; and forwarding the user data to a host computer or a wireless device.

### Group C Embodiments

Example Embodiment 7. A wireless device comprising: processing circuitry configured to perform any of the steps of any of the Group A embodiments; and power supply circuitry configured to supply power to the wireless device.

Example Embodiment 8. A base station comprising: processing circuitry configured to perform any of the steps of any of the Group B embodiments; power supply circuitry configured to supply power to the wireless device.

Example Embodiment 9. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 10. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

Example Embodiment 11. The communication system of the previous embodiment further including the base station.

Example Embodiment 12. The communication system of the previous 2 embodiments, further including the UE, wherein the UE is configured to communicate with the base station.

Example Embodiment 13. The communication system of the previous 3 embodiments, wherein: the processing circuitry of the host computer is configured to execute a host application, thereby providing the user data; and the UE comprises processing circuitry configured to execute a client application associated with the host application.

Example Embodiment 14. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group B embodiments.

Example Embodiment 15. The method of the previous embodiment, further comprising, at the base station, transmitting the user data.

Example Embodiment 16. The method of the previous 2 embodiments, wherein the user data is provided at the host computer by executing a host application, the method further comprising, at the UE, executing a client application associated with the host application.

Example Embodiment 17. A user equipment (UE) configured to communicate with a base station, the UE comprising a radio interface and processing circuitry configured to performs any of the previous 3 embodiments.

Example Embodiment 18. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group A embodiments.

Example Embodiment 19. The communication system of the previous embodiment, wherein the cellular network further includes a base station configured to communicate with the UE.

Example Embodiment 20. The communication system of the previous 2 embodiments, wherein: the processing circuitry of the host computer is configured to execute a host application, thereby providing the user data; and the UE's processing circuitry is configured to execute a client application associated with the host application.

Example Embodiment 21. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the Group A embodiments.

Example Embodiment 22. The method of the previous embodiment, further comprising at the UE, receiving the user data from the base station.

Example Embodiment 23. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the Group A embodiments.

Example Embodiment 24. The communication system of the previous embodiment, further including the UE.

Example Embodiment 25. The communication system of the previous 2 embodiments, further including the base station, wherein the base station comprises a radio interface configured to communicate with the UE and a communication interface configured to forward to the host computer the user data carried by a transmission from the UE to the base station.

Example Embodiment 26. The communication system of the previous 3 embodiments, wherein: the processing circuitry of the host computer is configured to execute a host application; and the UE's processing circuitry is configured to execute a client application associated with the host application, thereby providing the user data.

Example Embodiment 27. The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Example Embodiment 28. A method implemented in a communication system including a host computer, a base station and a user equipment (UE), the method comprising: at the host computer, receiving user data transmitted to the base station from the UE, wherein the UE performs any of the steps of any of the Group A embodiments.

Example Embodiment 29. The method of the previous embodiment, further comprising, at the UE, providing the user data to the base station.

Example Embodiment 30. The method of the previous 2 embodiments, further comprising: at the UE, executing a client application, thereby providing the user data to be transmitted; and at the host computer, executing a host application associated with the client application.

Example Embodiment The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

Example Embodiment 32. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

Example Embodiment 33. The communication system of the previous embodiment further including the base station.

Example Embodiment The communication system of the previous 2 embodiments, further including the UE, wherein the UE is configured to communicate with the base station.

Example Embodiment 35. The communication system of the previous 3 embodiments, wherein: the processing circuitry of the host computer is configured to execute a host application; the UE is configured to execute a client application associated with the host application, thereby providing the user data to be received by the host computer.

Example Embodiment 36. A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A embodiments.

Example Embodiment 37. The method of the previous embodiment, further comprising at the base station, receiving the user data from the UE.

Example Embodiment 38. The method of the previous 2 embodiments, further comprising at the base station, initiating a transmission of the received user data to the host computer.

1. A method performed by a target Central Unit, CU, during a handover of a migrating node from source CU and source Distributed Unit, DU, to the target CU and a target DU, the method comprising:
transmitting, to the migrating node via the target DU, a first handover command for at least one child node of the migrating node being handed over from the source CU and source DU to the target CU and target DU.

2. The method of claim 1, wherein:
the migrating node is an Integrated Access and Backhaul node, IAB node;
the handover of the migrating node is an inter-CU IAB migration;
the first CU is a first donor CU during the inter-CU IAB migration;
the second CU is a second donor CU during the inter-CU IAB migration; and
the target DU is a target donor DU.

3. The method of claim 1, further comprising receiving a handover request from the source CU, the handover request indicating the migrating node and the at least one child node for handover from the source CU to the target CU.

4. The method of claim 3, further comprising:
transmitting, to the migrating node via the source CU, a handover request acknowledgment message, wherein the handover request acknowledgement message comprises a second handover command for only the migrating node, and wherein the handover request acknowledgement message is transmitted to the migrating node before the first handover command is transmitted to the at least one child node.

5. The method of claim 4, wherein prior to transmitting the first handover command, the method further comprises:
receiving, from an MT of the migrating node, an RRC Reconfiguration Complete message; and
setting up an F1 connection between the migrating node and the target CU.

6.-8. (canceled)

9. The method of claim 1, further comprising receiving at least reconfiguration complete message from the at least one child node, the at least one response message indicating that the at least one child node received the first handover command.

10.-12. (canceled)

13. A method performed by a migrating node during a handover from a source Central Unit, CU, and a source Distributed Unit, DU, to a target CU and a target DU, the method comprising:
receiving, via the source CU, a first handover command from the target CU, the first handover command for at least one child node of the migrating node being handed over from the source CU and source DU to the target CU and target DU; and
transmitting the message to the at least one child node.

14. (canceled)

15. The method of claim 13, wherein prior to receiving the first handover command, the method further comprises:
receiving, via the source CU, a handover request acknowledgment message, wherein the handover request acknowledgement message comprises a second handover command intended only for the migrating node.

16. The method of claim 15, wherein prior to receiving the second handover command, the method further comprises:
transmitting, via the source CU, an RRC Reconfiguration Complete message to the target CU, and
wherein an F1 connection is set up between the migrating node and the target CU based on the RRC Reconfiguration Complete message.

17.-20. (canceled)

21. The method of claim 13, further comprising:
receiving at least one reconfiguration complete message from the at least one child node, the at least one reconfiguration complete message indicating that the at least one child node received the first handover command; and
transmitting, to the target CU, the at least one reconfiguration complete message from the at least one child node.

22.-26. (canceled)

27. The method of claim 13, wherein at least one child node of the migrating node comprises a child IAB node that is a parent with respect to at least one additional child node, and wherein the method further comprises:
receiving a third handover command for the at least one additional child node being handed over from the source CU and source DU to the target CU and target DU with the child IAB node; and
transmitting the third handover command to the at least one additional child IAB node.

28. (canceled)

29. A method performed by a migrating node during a handover from a source Central Unit, CU, and source Distributed Unit, DU, to a target CU and target DU, the migrating node being a child node of a parent migrating node, the migrating node being a parent node to at least one additional child node, the method comprising:
receiving via the parent migrating node, a first handover command from the target CU, the first handover command for the at least one additional child node that is being handed over from the source CU and source DU to the target CU and target DU with the migrating node; and
transmitting the message to the at least one additional child node of the migrating node.

30. (canceled)

31. The method of claim 29, wherein prior to receiving the first handover command, the method further comprises:
receiving, via the parent migrating node, a handover request acknowledgment message, wherein the handover request acknowledgement message comprises a second handover command intended for the migrating node.

32. The method of claim 31, wherein prior to receiving the second handover command, the method further comprises:
transmitting, via the parent migrating node, an RRC Reconfiguration Complete message to the target CU, and
wherein an F1 connection is set up between the migrating node and the target CU based on the RRC Reconfiguration Complete message.

33.-34. (canceled)

35. The method of claim 29, further comprising:
transmitting, via the parent migrating node, at least one reconfiguration complete message to the target CU, the at least one reconfiguration complete message indicating that the migrating node received the first handover command.

36.-40. (canceled)

41. A target Central Unit, CU, comprising:
processing circuitry configured, during a handover of a migrating node from source CU and source Distributed Unit, DU, to the target CU and a target DU, to:
transmit, to the target DU, a first handover command for at least one child node of the migrating node being handed over from the source CU and source DU to the target CU and target DU.

42. (canceled)

43. The target CU of claim 41, wherein the processing circuitry is configured to receive a handover request from the source CU, the handover request indicating the migrating node and the at least one child node for handover from the source CU to the target CU.

44. The target CU of claim 43, wherein the processing circuitry is configured to:
transmit, to the migrating node via the source CU, a handover request acknowledgment message, wherein the handover request acknowledgement message comprises a second handover command for only the migrating node, and wherein the handover request acknowledgement message is transmitted to the migrating node before the first handover command is transmitted to the at least one child node.

45. The target CU of claim 44, wherein prior to transmitting the first handover command, the processing circuitry is configured to:
receive, from an MT of the migrating node, an RRC Reconfiguration Complete message; and
set up an F1 connection between the migrating node and the target CU.

46.-52. (canceled)

53. A migrating node comprising:
processing circuitry configured to:
during a handover from a source Central Unit, CU and a source Distributed Unit, DU, to a target CU and a target DU, receive, via the source CU, a first handover command from the target CU, the first handover command for at least one child node of the migrating node being handed over from the source CU and source DU to the target CU and target DU; and
transmit the message to the at least one child node.

54. (canceled)

55. The migrating node of claim 53, wherein prior to receiving the first handover command, the processing circuitry is configured to:
receiving, via the source CU, a handover request acknowledgment message, wherein the handover request acknowledgement message comprises a second handover command intended only for the migrating node.

56. The migrating node of claim 55, wherein prior to receiving the second handover command, the processing circuitry is configured to:
transmit, via the source CU, an RRC Reconfiguration Complete message to the target CU, and
wherein an F1 connection is set up between the migrating node and the target CU based on the RRC Reconfiguration Complete message.

57.-68. (canceled)

69. A migrating node being a child node of a parent migrating node and being a parent node to at least one additional child node, the migrating node comprising:
processing circuitry configured to:
during a handover from a source Central Unit, CU, and source Distributed Unit, DU, to a target CU and target DU, receive, via the parent migrating node, a first handover command from the target CU, the first handover command for the at least one additional child node that is being handed over from the source CU and source DU to the target CU and target DU with the migrating node; and
transmit the message to the at least one additional child node of the migrating node.

70. (canceled)

71. The migrating node of claim 69, wherein prior to receiving the first handover command, the processing circuitry is configured to:
receive, via the parent migrating node, a handover request acknowledgment message, wherein the handover request acknowledgement message comprises a second handover command intended for the migrating node.

72. The migrating node of claim 71, wherein prior to receiving the second handover command, the processing circuitry is configured to:
transmit, via the parent migrating node, an RRC Reconfiguration Complete message to the target CU, and
wherein an F1 connection is set up between the migrating node and the target CU based on the RRC Reconfiguration Complete message.

73.-80. (canceled)
